(19) United States
(12) Patent Application Publication
(10) Pub. No.: US 2024/0283616 A1
(43) Pub. Date: Aug. 22, 2024

(54) METHOD, DEVICE AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/570,714

(22) PCT Filed: Jun. 17, 2021
(86) PCT No.: PCT/CN2021/100725

§ 371 Date: Dec. 15, 2023

(51) Int. Cl. H04L 5/00; H04W 72/21; H04W 72/232

(52) U.S. Cl. CPC H04L 5/0055; H04W 72/21; H04W 72/232

(57) ABSTRACT

Embodiments of the present disclosure relate to methods, devices and computer readable media for communication. A terminal device receives a first physical downlink control channel (PDCCH) which indicates a first Transmission Configuration Indication (TCI) state and receives a second PDCCH which indicates a second TCI state from a network device. If the reception of the second PDCCH is later than the reception of the first PDCCH, the terminal device performs a communication with the network device with the second TCI. In this way, it avoids ambiguity between two TCI states. Further, it also avoids unnecessary beam switching.

### TECHNICAL FIELD

Embodiments of the present disclosure generally relate to the field of telecommunication, and in particular, to methods, devices and computer storage media for communication.

### BACKGROUND

In the third generation partnership project (3GPP) meeting RAN #86, it is agreed to support enhancement on multi-beam operation, mainly targeting the frequency range 2 (FR2) while also applicable to the frequency range 1 (FR1). It is agreed to identify and specify features to facilitate more efficient (lower latency and overhead) downlink (DL) and uplink (UL) beam management. For example, it is proposed to support common beam(s) for data and control information transmission/reception for both DL and UL. It is also proposed to support a unified Transmission Configuration Indication (TCI) framework for DL and UL beam indication.

### SUMMARY

In general, embodiments of the present disclosure provide methods, devices and computer storage media for redundancy version determination.

In a first aspect, there is provided a method of communication. The method comprises: receiving, at a terminal device and from a network device, a first physical downlink control channel (PDCCH) indicating a first transmission configuration indicator (TCI) state; receiving, from the network device, a second PDCCH indicating a second TCI state; and in accordance with a determination that the reception of the second PDCCH is later than the reception of the first PDCCH, performing a communication with the network device with the second TCI state after a period of time.

In a second aspect, there is provided a method of communication. The method comprises: receiving, at a terminal device and from a network device, a first number of activated transmission configuration indicator (TCI)codepoints; receiving, from the network device, a configuration of a second number of codepoints in a downlink control information (DCI) field, wherein the second number is smaller than the first number; and one predetermined value of the DCI field is to indicate a same TCI state which has been applied for a communication with the network device.

In a third aspect, there is provided a method of communication. The method comprises: transmitting, at a network device and to a terminal device, a first physical downlink control channel (PDCCH) indicating a first transmission configuration indicator (TCI) state; transmitting, to the terminal device, a second PDCCH indicating a second TCI state; and in accordance with a determination that the reception of the second PDCCH is later than the reception of the first PDCCH, performing a communication with the terminal device with the second TCI state after a period of time.

In a fourth aspect, there is provided a method of communication. The method comprises: transmitting, at a network device and to a terminal device, a first number of activated transmission configuration indicator (TCI) codepoints; and transmitting, to the terminal device, a configuration of a second number of codepoints in a downlink control information (DCI) field, wherein the second number is smaller than the first number; and one predetermined value of the DCI field is to indicate a same TCI state which has been applied for a communication with the network device.

In a fifth aspect, there is provided a terminal device. The terminal device comprises a processor and a memory coupled to the processor. The memory stores instructions that when executed by the processor, cause the terminal device to perform the method according to the first aspect of the present disclosure.

In a sixth aspect, there is provided a terminal device. The terminal device comprises a processor and a memory coupled to the processor. The memory stores instructions that when executed by the processor, cause the terminal device to perform the method according to the second aspect of the present disclosure.

In a seventh aspect, there is provided a network device. The network device comprises a processor and a memory coupled to the processor. The memory stores instructions that when executed by the processor, cause the network to perform the method according to the third aspect of the present disclosure.

In an eighth aspect, there is provided a network device. The network device comprises a processor and a memory coupled to the processor. The memory stores instructions that when executed by the processor, cause the network device to perform the method according to the fourth aspect of the present disclosure.

In a ninth aspect, there is provided a computer readable medium having instructions stored thereon. The instructions, when executed on at least one processor, cause the at least one processor to perform the method according to the first, second, third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a signaling flow for communication according to some example embodiments of the present disclosure;

FIGS. 3A-3D illustrate examples of PDCCH in accordance with some embodiments of the present disclosure;

FIG. 4 illustrates an example of communications in accordance with some embodiments of the present disclosure;

FIG. 5 illustrates an example of communications in accordance with some embodiments of the present disclosure;

FIG. 6 illustrates an example of TCI field in accordance with some embodiments of the present disclosure;

FIG. 7 illustrates a flow chart of an example method of communication implemented at a terminal device in accordance with some embodiments of the present disclosure;

FIG. 8 illustrates a flow chart of an example method of communication implemented at a terminal device in accordance with some embodiments of the present disclosure;

FIG. 9 illustrates a flow chart of an example method of communication implemented at a network device in accordance with some embodiments of the present disclosure;

FIG. 10 illustrates a flow chart of an example method of communication implemented at a network device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Generally speaking, for uplink (UL) transmission, one TRP usually corresponds to one SRS resource set. As used herein, the term “single-TRP for UL” refers to that a single SRS resource set is used for performing related transmissions (such as, PUSCH transmissions), and the term “multi-TRP for UL” refers to that a plurality of SRS resource sets are used for performing related transmissions (such as, PUSCH transmissions).

As mentioned above, there are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA; ii. Unified TCI framework for DL and UL beam indication; iii. Enhancement on signaling mechanisms for the above features to improve latency and efficiency with more usage of dynamic control signaling (as opposed to RRC).

It is proposed to support L1-based beam indication using at least UE-specific (unicast) DCI to indicate joint or separate DL/UL beam indication from the active TCI states. The existing DCI formats 1_1 and 1_2 are reused for beam indication and it supports a mechanism for UE to acknowledge successful decoding of beam indication. The ACK/NAK of the PDSCH scheduled by the DCI carrying the beam indication can be used as an ACK also for the DCI.

It is also proposed to support activation of one or more TCI states via medium access control (MAC) control element (CE) analogous to Release.15/16. At least for the single activated TCI state, the activated TCI state is applied.

For beam indication with Rel-17 unified TCI, support DCI format 1_1/1_2 without DL assignment, acknowledgement/negative acknowledgement (ACK/NACK) mechanism is used analogously to that for semi-persistent scheduling (SPS) PDSCH release with both type-1 and type-2 HARQ-ACK codebook. Upon a successful reception of the beam indication DCI, the UE reports an ACK.

For type-1 HARQ-ACK codebook, a location for the ACK information in the HARQ-ACK codebook is determined based on a virtual PDSCH indicated by the TDRA field in the beam indication DCI, based on the time domain allocation list configured for PDSCH. For type-2 HARQ-ACK codebook, a location for the ACK information in the HARQ-ACK codebook is determined according to the same rule for SPS release. The ACK is reported in a PUCCH k slots after the end of the PDCCH reception where k is indicated by the PDSCH-to-HARQ_feedback timing indicator field in the DCI format, or provided dl-DataToUL-ACK or dl-DataToUL-ACK-ForDCI-Format1-2-r16 if the PDSCH-to-HARQ_feedback timing indicator field is not present in the DCI.

When used for beam indication, configured scheduling-radio network temporary identifier (CS-RNTI) is used to scramble the CRC for the DCI. The values of the following DCI fields are set as follows: RV=all ‘1’s; MCS=all ‘1’s; NDI=0; and set to all ‘0’s for FDRA Type 0, or all ‘1’s for FDRA Type 1, or all ‘0’s for dynamicSwitch (same as in Table 10.2-4 of TS38.213).

The TCI field can be used to signal the following: 1) Joint DL/UL TCI state, 2) DL-only TCI state (for separate DL/UL TCI), 3) UL-only TCI state (for separate DL/UL TCI).

In addition, the following DCI fields are being used in Rel-16: identifier for DCI formats; carrier indicator; bandwidth part indicator; time domain resource assignment (TDRA); downlink assignment index (if configured); transmit power control (TPC) command for scheduled PUCCH; PUCCH resource indicator; PDSCH-to-HARQ_feedback timing indicator (if present). The remaining unused DCI fields and codepoints are reserved in Release 17.

It is also proposed to support UE to report whether or not to support TCI update by DCI format 1_1/1_2. For a UE supporting TCI update by DCI format 1_1/1_2, it must support TCI update by using DCI 1_1/1_2 with DL assignment, and support of the above feature for TCI update by DCI format 1_1/1_2 without DL assignment is UE optional.

On Rel-17 DCI-based beam indication, regarding application time of the beam indication, the first slot that is at least X ms or Y symbols after the last symbol of the acknowledgment of the joint or separate DL/UL beam indication.

According to TS 38.212 section 7.3.1.2.2 Format 1_1, Transmission configuration indication—0 bit if higher layer parameter tci-PresentInDCI is not enabled; otherwise 3 bits as defined in Clause 5.1.5 of [6, TS38.214]. According to TS 38.212 section 7.3.1.2.3 Format 1_2, Transmission configuration indication—0 bit if higher layer parameter tci-PresentDCI-1-2 is not configured; otherwise 1 or 2 or 3 bits determined by higher layer parameter tci-PresentDCI-1-2 as defined in Clause 5.1.5 of [6, TS38.214].

The UE receives an activation command, as described in clause 6.1.3.14 of [10, TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2. For example, if the number of bits for the DCI field ‘Transmission Configuration Indication’ of DCI format 1_2 or the number of bits of higher layer parameter tci-PresentDCI-1-2 is 1 bit, then S=2. For another example, if the number of bits for the DCI field ‘Transmission Configuration Indication’ of DCI format 1_2 or the number of bits of higher layer parameter tci-PresentDCI-1-2 is 2 bits, then S=4. For another example, if the number of bits for the DCI field ‘Transmission Configuration Indication’ of DCI format 1_2 or the number of bits of higher layer parameter tci-PresentDCI-1-2 is 3 bits, then S=8.

Moreover, DCI format 1_1/1_2 with and without DL assignment can be used for dynamic beam indication. If beam indication is indicated by DCI format with DL scheduling, ACK/NACK of PDSCH can be used to indicate ACK of the beam indication, and after a timing, indicated beam can be applied.

However, if a new beam applied from first slot that is at least X ms or Y symbols after the last symbol of the acknowledgment, there may be some cases that a same slot is identified for several HARQ-ACK feedback (especially in case of sub-slot HARQ-ACK feedback), and there are several new beams applicable from the same first slot, and which one should be applied needs to be clarified. Further, it's possible that a first PDCCH with data scheduling, and a second PDCCH without data scheduling, and the first PDCCH is earlier than the second PDCCH, and the first HARQ-ACK feedback for the first PDCCH is later than the second HARQ-ACK feedback for the second PDCCH. It's possible that a first PDCCH with data scheduling, and a second PDCCH without data scheduling, and the first PDCCH is earlier than the second PDCCH, and the first HARQ-ACK feedback for the data scheduling based on the first PDCCH is later than the second HARQ-ACK feedback for the second PDCCH. In case of TCI field present, size of TCI field in DCI format 1_1 and 1_2 may be different, there may be cases that some TCI codepoints cannot be indicated by DCI format 1_2.

In order to solve at least part of the above problems, solutions on beam indication are proposed. A terminal device receives a first PDCCH which indicates a first TCI state and receives a second PDCCH which indicates a second TCI sate from a network device. If the reception of the second PDCCH is later than the reception of the first PDCCH, the terminal device performs a communication with the network device with the second TCI. In this way, it avoids ambiguity between two TCI states. Further, it also avoids unnecessary beam switching.

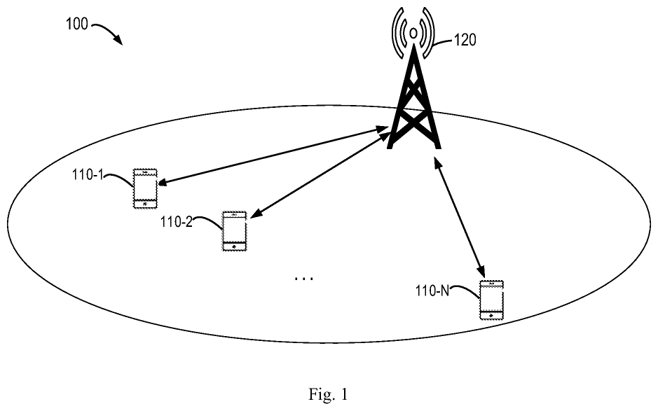

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. Only for the purpose of illustrations, embodiments of the present disclosure are described with the reference to the terminal device 110-1.

The communication system 100 further comprises a network device 120. In the communication system 100, the network device 120 and the terminal devices 110 can communicate data and control information to each other. The numbers of devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHZ, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure.

In some embodiments, the TRPs may be explicitly associated with different higher-layer configured identities. For example, a higher-layer configured identity can be associated with a Control Resource Set (CORESET), a group of CORESETs, a reference signal (RS), a set of RS, a Transmission Configuration Indication (TCI) state or a group of TCI states, which is used to differentiate between transmissions between different TRPs and the terminal device 110-1. When the terminal device 110-1 receives two DCIs from two CORESETs which are associated with different higher-layer configured identities, the two DCIs are indicated from different TRPs. Further, the TRPs may be implicitly identified by a dedicated configuration to the physical channels or signals. For example, a dedicated CORESET, a RS, and a TCI state, which are associated with a TRP, are used to identify a transmission from a different TRP to the terminal device 110. For example, when the terminal device 110-1 receives a DCI from a dedicated CORESET, the DCI is indicated from the associated TRP dedicated by the CORESET. In some embodiments, the RS may be at least one of CSI-RS, SRS, positioning RS, uplink DMRS, downlink DMRS, uplink PTRS and downlink PTRS.

In the repeated transmission or reception via the two TRPs, the network device 120 may select a repetition scheme from among a number of available repetition schemes. The repetition scheme may specify a transmission manner for the network device 120 to use the two TRPs cooperatively, for example, a multiplexing scheme between the two TRPs, the respective resource allocations for the two TRPs, or the like.

For example, schemes for multi-TRP/multi-panel based URLLC, scheduled by single downlink control information (DCI) at least, are clarified as following.

Scheme 1 (SDM): n (n<=Ns) TCI states within the single slot, with overlapped time and frequency resource allocation.

Scheme 1a: Each transmission occasion is a layer or a set of layers of the same TB, with each layer or layer set is associated with one TCI and one set of DMRS port(s). Single codeword with one RV is used across all spatial layers or layer sets. From the UE perspective, different coded bits are mapped to different layers or layer sets with the same mapping rule as in Rel-15.

Scheme 1b: Each transmission occasion is a layer or a set of layers of the same TB, with each layer or layer set is associated with one TCI and one set of DMRS port(s). Single codeword with one RV is used for each spatial layer or layer set. The RVs corresponding to each spatial layer or layer set can be the same or different. Codeword-to-layer mapping when total number of layers<=4 is for future study.

Scheme 1c: One transmission occasion is one layer of the same TB with one DMRS port associated with multiple TCI state indices, or one layer of the same TB with multiple DMRS ports associated with multiple TCI state indices one by one.

In addition, it is indicated that applying different MCS/modulation orders for different layers or layer sets can be discussed.

Scheme 2 (FDM): n (n<=N_{f}) TCI states are within the single slot, with non-overlapped frequency resource allocation. Each non-overlapped frequency resource allocation is associated with one TCI state. Same single/multiple DMRS port(s) are associated with all non-overlapped frequency resource allocations.

Scheme 2a: Single codeword with one RV is used across full resource allocation. From UE perspective, the common RB mapping (codeword to layer mapping as in Rel-15) is applied across full resource allocation. In some embodiments, a terminal device may be configured or set with FDMschemeA by a high layer parameter. For example, the high layer parameter may be an RRC parameter. For example, the high layer parameter may be URLLCSchemeEnabler.

Scheme 2b: Single codeword with one RV is used for each non-overlapped frequency resource allocation. The RVs corresponding to each non-overlapped frequency resource allocation can be the same or different. In some embodiments, a terminal device may be configured or set with FDMschemeB by a high layer parameter. For example, the high layer parameter may be an RRC parameter. For example, the high layer parameter may be URLLCSchemeEnabler.

In addition, it is indicated that applying different MCS/modulation orders for different non-overlapped frequency resource allocations can be discussed. It is also indicated that details of frequency resource allocation mechanism for FDM 2a/2b with regarding to allocation granularity, time domain allocation can be discussed.

Scheme 3 (TDM or intra-slot repetition): n (n<=Nₜ₁) TCI states within the single slot, with non-overlapped time resource allocation. Each transmission occasion of the TB has one TCI and one RV with the time granularity of mini-slot. All transmission occasion (s) within the slot use a common MCS with same single or multiple DMRS port(s). RV/TCI state can be same or different among transmission occasions. Channel estimation interpolation across mini-slots with the same TCI index is for future study. In some embodiments, a terminal device may be configured or set with TDMschemeA by a high layer parameter. For example, the high layer parameter may be an RRC parameter. For example, the high layer parameter may be URLLCSchemeEnabler.

Scheme 4 (TDM or inter-slot repetition): n (n<=Nₜ₂) TCI states with K (n<=K) different slots. Each transmission occasion of the TB has one TCI and one RV. All transmission occasion (s) across K slots use a common MCS with same single or multiple DMRS port(s). RV/TCI state can be same or different among transmission occasions. Channel estimation interpolation across slots with the same TCI index is for future study.

In addition, before transmitting data to the terminal device 110, the network device 120 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV), as defined in the 3GPP specifications. It is to be understood that the transmission parameters indicated in the control information 135 are not limited to the ones as listed above. Embodiments of the present disclosure may equally applicable to control information including any transmission parameters.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably.

As specified in the 3GPP specifications (TS 38.214), a UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DMRS ports of the PDSCH, the DMRS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where μ is the SCS configuration for the PUCCH. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

In some embodiments, if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format 1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 1_0), the UE assumes that the TCI field is not present in the DCI (for example DCI format 1_1 or DCI format 1_2 or DCI format 1_0) of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DMRS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI (for example, DCI format 1_2) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCHI-Config that contains two different values of coresetPoolIndex in different ControlResourceSets,
the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetld among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enableDefaultBeam-ForCCS:
The timeDurationForQCL is determined based on the subcarrier spacing of the scheduled PDSCH. If μ_{PDCCH}<μ_{PDSCH} an additional timing delay

$$d \frac{{2}^{μ} PDSCH}{{2}^{μ} PDCCH}$$

is added to the timeDurationForQCL, where d is defined in 5.2.1.5.1a-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location typc(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or
For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA′ with a CSI-RS resource in a NZP-CSI-RS-ResourceSet configured without higher layer parameter trs-Info and without higher layer parameter repetition and, when applicable, ‘typeD’ with the same CSI-RS resource.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If μPDCCH<μPDSCH an additional timing delay d is added to the timeDurationForQCL, where d is defined as 8 symbols if subcarrier spacing for the PDCCH is 15 kHz, or 8 symbols if subcarrier spacing for the PDCCH is 30 kHz, or 14 symbols if subcarrier spacing for the PDCCH is 60 KHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tei-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DMRS port(s) within one CDM (Code Domain Multiplexing) group in the DCI field “Antenna Port(s)”. When two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DMRS reception procedure” (for example, clause 5.1.6.2) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably. The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K in StartingSymbolOffsetK, it shall determine that the first symbol of the second PDSCH transmission occasion starts after K symbols from the last symbol of the first PDSCH transmission occasion. If the value K is not configured via the higher layer parameter StartingSymbolOffsetK, K=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTCIMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rvₛ is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214.

TABLE 5.1.2.1-2
Applied redundancy version when pdsch-
AggregationFactor is present

| rv_{id} indicated by | rv_{id} to be applied to the n^{th} transmission occasion | | | |
|---|---|---|---|---|
| the DCI scheduling | n mod | n mod | n mod | n mod |
| the PDSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5.1.2.1-3
Applied redundancy version for the second
TCI state when RVSeqOffset is present

| rv_{id} indicated | | | | |
|---|---|---|---|---|
| by the DCI | rv_{id} to be applied to the n^{th} transmission occasion | | | |
| scheduling | with second TCI state | | | |
| the PDSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

As specified in the 3GPP specifications (TS 38.214), For a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P_{BWP,i}′ is determined as “wideband”, the first

$$⌈ \frac{{n}_{PRB}}{2} ⌉$$

PRBs are assigned to the first TCI state and the remaining

$$⌊ \frac{{n}_{PRB}}{2} ⌋$$

PRBs are assigned to the second TCI state, where n_{PRB} is the total number of allocated PRBs for the UE. If P_{BWP,i}′ is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0, 1 are applied to the first and second TCI state, respectively.

In some embodiments, the terminal device 110-1 may be configured with a first PDCCH candidate and a second PDCCH candidate, where the first PDCCH candidate and the second PDCCH candidate are linked. For example, the linked first PDCCH candidate and second PDCCH candidate are applied for PDCCH repetition. For another example, the linked first PDCCH candidate and second PDCCH candidate are applied for same scheduling. For example, the scheduling may be at least one of downlink data scheduling, PDSCH scheduling, uplink data scheduling, PUSCH scheduling, downlink RS scheduling, uplink RS scheduling and PUCCH scheduling.

In some embodiments, the terminal device 110-1 may be configured with multiple control-resource sets (i.e. CORESET).

In some embodiments, a CORESET may consist of N_{RB}^{CORESET} resource blocks (RBs) in the frequency domain and N_{symb}^{CORESET} ∈{1, 2, 3} symbols in the time domain. In some embodiments, a control-channel element (CCE) consists of 6 resource-element groups (REGs) where a REG equals to one resource block during one orthogonal frequency-division multiplexing (OFDM) symbol. In some embodiments, REGs within a control-resource set are numbered in increasing order in a time-first manner, starting with 0 for the first OFDM symbol and the lowest-numbered resource block in the control resource set.

In some embodiments, one CORESET may be associated with one or more search space sets. One search space set may include or may be associated with one or more PDCCH candidates. In some embodiments, PDCCH monitoring periodicity and/or slot offset and/or symbol index within a slot can be configured per search space set. In some embodiments, one PDCCH candidate may be associated with or may correspond to a search space.

In some embodiments, a procedure may be defined for determining physical downlink control channel candidates for the terminal device 110. That is, determining the CCE index(es) for each of a plurality of PDCCH candidates that is potentially to be used for PDCCH transmission between the network device 120 and the terminal device 110. With the CCE index for PDCCH candidates determined, the terminal device 110-1 can perform blind detection on these PDCCH candidates. Once PDCCH transmission is detected or received on a PDCCH candidate, the terminal device 110-1 may decode it to obtain information such as DCI.

In some embodiments, the terminal device 110-1 may assume that a Demodulation Reference Signal (DM-RS) antenna port associated with PDCCH reception(s) in the CORESET is quasi co-located (QCLed) with the one or more reference signal (RS) configured by a transmission control indicator (TCI) state, where the TCI state is indicated for the CORESET, if any.

In some embodiments, the terminal device 110-1 may assume that a DM-RS antenna port associated with PDCCH reception(s) in the CORESET is quasi co-located (QCLed) with a Synchronization Signal/Physical Broadcast Channel (SS/PBCH) block the UE identified during a most recent random access procedure not initiated by a PDCCH order that triggers a contention-free random access procedure, if no Medium Access Control (MAC) control element (CE) activation command indicating a TCI state for the CORESET is received after the most recent random access procedure the one or more reference signal (RS) configured by a TCI state, where the TCI state is indicated for the CORESET, if any.

In some embodiments, the network device 120 may transmit, to the terminal device 110, a configuration (e.g. 210) indicative of N PDCCH candidates, where N is a positive integer. For example, 1≤N≤32. For another example, N=2. For example, the configuration may be transmitted via any of Radio Resource Control (RRC) signaling, Medium Access Control (MAC) control element (CE) and DCI.

In some embodiments, the network device 120 may transmit, to the terminal device 110, one or more configurations for a first PDCCH candidate and a second PDCCH candidate. In some embodiments, the first PDCCH candidate may be comprised in a first search space or a first search space set. In some embodiments, the first search space or the first search space set may be associated with a first CORESET. In some embodiments, the first CORESET may be associated or configured with a first TCI state T1 or a first set of QCL parameters Q1. In some embodiments, the second PDCCH candidate may be comprised in a second search space or a second search space set. In some embodiments, the second search space or the second search space set may be associated with a second CORESET. In some embodiments, the second CORESET may be associated or configured with a second TCI state T2 or a second set of QCL parameters Q2. In some embodiments, T1 may be different from T2. In some embodiments, Q1 may be different from Q2.

In some embodiments, the first PDCCH candidate and the second PDCCH candidate may be configured to be explicitly linked/associated together. For example, the terminal device 110-1 is able to know the linking/association before decoding. In some embodiments, there may be a first PDCCH/DCI transmitted/received in the first PDCCH candidate. In some embodiments, there may be a second PDCCH/DCI transmitted/received in the second PDCCH candidate. In some embodiments, the DCI payload and/or the coded bits and/or the number of CCEs in the first PDCCH/DCI are same with the second PDCCH/DCI. In some embodiments, the first PDCCH/DCI and the second PDCCH/DCI schedule a same communication between the network device 120 and the terminal device 110. For example, the communication may be at least one of PDSCH, PUSCH, Sounding Reference Signal (SRS), Channel State Information-Reference Signal (CSI-RS), transport block, an active UL BWP change, and an active DL BWP change, PUCCH.

In some embodiment, the network device 120 may transmit, to the terminal device 110, a configuration indicating the first PDCCH candidate and the second PDCCH candidate are linked together for PDCCH repetition. In some embodiment, the network device 120 may transmit, to the terminal device 110, a configuration indicating the first search space (or the first search space set or the first CORESET) and the second search space (or the second search space set or the second CORESET) are linked together. For example, the configuration can be transmitted from the network device 120 to the terminal device 110-1 via any of the following: Radio Resource Control (RRC) signaling, Medium Access Control (MAC) control element (CE) or DCI. For example, the first PDCCH candidate and the second PDCCH candidate can be used to carry a single or a same DCI format (or DCI payload).

In some embodiments, the first PDCCH candidate may end no later or earlier than the second PDCCH candidate in time domain.

In some embodiments, the network device 120 may transmit at least one configuration about a first CORESET and a second CORESET to the terminal device 110.

In some embodiments, the at least one configuration may configure a first set of search spaces which is associated with the first CORESET. In some embodiments, the at least one configuration may configure a second set of search spaces which is associated with the second CORESET. In some embodiments, the at least one configuration may configure a first set of PDCCH candidates in a first search space of the first set of search spaces. In some embodiments, the at least one configuration may configure a second set of PDCCH candidates in a second search space of the second set of search spaces. In some embodiments, the at least one configuration may configure that a first PDCCH candidate in the first search space of the first set of search spaces associated with the first CORESET is linked or associated or related to a second PDCCH candidate in the second search space of the second set of search spaces associated with the second CORESET. For example, the terminal device knows the linking or association or relationship before decoding the PDCCH or DCI in the first and second PDCCH candidates. In some embodiments, the first and second PDCCH candidates may be used for PDCCH repetitions. For example, encoding and/or rate matching of the PDCCH or DCI in the PDCCH in the first PDCCH candidate and/or the second PDCCH candidate is based on one repetition (for example, PDCCH or DCI in the PDCCH in one of the first and second PDCCH candidates). For example, the same coded bits are repeated for the other repetition. For another example, each repetition has the same number of control channel elements (CCEs) and coded bits, and corresponds to the same DCI payload. In some embodiments, the at least one configuration may be transmitted/received via at least one of RRC signaling, MAC CE and DCI.

In some embodiments, a PDCCH candidate in the first search space set is linked with the a PDCCH candidate in the second search space set based on the two PDCCH candidates having the same aggregation level and same candidate index. For example, the aggregation level of the first PDCCH candidate and the aggregation level of the second PDCCH candidate are same. For another example, the candidate index of the first PDCCH candidate and the candidate index of the second PDCCH candidate are same.

In some embodiments, the network device 120 may transmit one or more configurations of a third CORESET to the terminal device 110. The one or more configurations may indicate two active TCI states for the third CORESET. For example, the terminal device 110-1 may detect/decode PDCCH in the search space sets which associated with the third CORESET with the two active TCI states.

In some embodiments, the network device 120 may transmit one or more configurations for a first number of PDSCH/PUSCH/PUCCH transmissions/receptions/repetitions/occasions to the terminal device 110. For example, the first number is denoted as G. For example, 1≤G≤32. For another example, G may be at least one of {1, 2, 3, 4, 5, 6, 7, 8, 16, 32}. In some embodiments, the network device 120 may transmit a scheduling for the first number of PDSCH/PUSCH/PUCCH transmissions/receptions/repetitions/occasions in a single DCI/PDCCH or in PDCCH in linked PDCCH candidates to the terminal device 110. In some embodiments, there may be two TCI states (e.g. first TCI state and second TCI state) or two spatial relation info (e.g. first spatial relation info and a second spatial relation info) indicated/configured in the single DCI/PDCCH or in the PDCCH in linked PDCCH candidates.

In some embodiments, if M≥2, there may be two sets of PDSCH/PUSCH/PUCCH transmissions/receptions/repetitions/occasions for the plurality of PDSCH/PUSCH/PUCCH transmissions/receptions/repetitions/occasions (e.g., set 1 and set 2), and set 1 with a second number of PDSCH/PUSCH/PUCCH transmissions/receptions/repetitions/occasions (second number is G1, G1 is a positive integer, e.g. G1=G/2 or G1=ceil(G/2) or G1=floor(G/2)), and set 2 with a third number of PDSCH/PUSCH/PUCCH transmissions/receptions/repetitions/occasions (third number is G2, and G2=G−G1). In some embodiments, the set 1 of PDSCH/PUSCH/PUCCH transmissions/receptions/repetitions/occasions is transmitted/received with the first TCI state or the first spatial relation info, and the set 2 of PDSCH/PUSCH/PUCCH transmissions/receptions/repetitions/occasions is transmitted/received with the second TCI state or the second spatial relation info.

In some embodiments, the network device 120 may configure a mapping type to the terminal device 110. For example, the mapping type may indicate the association between the TCI states and the PDSCH/PUSCH/PUCCH transmissions/receptions/repetitions/occasions. In some embodiments, the network device 120 may configure (e.g. 210) cyclic mapping type to the terminal device 110, and the network device may configure the first number of PDSCH/PUSCH/PUCCH transmissions/receptions/repetitions/occasions to be larger than 2. And the first and second TCI states are applied to the first and second PDSCH/PUSCH/PUCCH transmissions/receptions/repetitions/occasions, respectively, and the same TCI mapping pattern continues to the remaining PDSCH/PUSCH/PUCCH transmissions/receptions/repetitions/occasions. In some embodiments, the network device 120 may configure sequential mapping type to the terminal device 110, and the network device may configure the first number of PDSCH/PUSCH/PUCCH transmissions/receptions/repetitions/occasions to be larger than 2. And the first TCI state is applied to the first and second PDSCH/PUSCH/PUCCH transmissions/receptions/repetitions/occasions, and the second TCI state is applied to the third and/or fourth PDSCH/PUSCH/PUCCH transmissions/receptions/repetitions/occasions, and same TCI mapping pattern continues to the remaining PDSCH/PUSCH/PUCCH transmissions/receptions/repetitions/occasions. In some embodiments, the network device 120 may configure the first number of PDSCH/PUSCH/PUCCH transmissions/receptions/repetitions/occasions to be 2. And the first TCI state is applied to the first PDSCH/PUSCH/PUCCH transmission/reception/repetition/occasion, and the second TCI state is applied to the second PDSCH/PUSCH/PUCCH transmission/reception/repetition/occasion.

When a UE configured by the higher layer parameter repetitionScheme set to ‘fdmSchemeA’ or ‘fdmSchemeB’, and the UE is indicated with two TCI states in a codepoint of the DCI field ‘Transmission Configuration Indication’ and DM-RS port(s) within one CDM group in the DCI field ‘Antenna Port(s)’, the UE shall receive a single PT-RS port which is associated with the lowest indexed DM-RS antenna port among the DM-RS antenna ports assigned for the PDSCH, a PT-RS frequency density is determined by the number of PRBs associated to each TCI state, and a PT-RS resource element mapping is associated to the allocated PRBs for each TCI state.

In addition to normal data communications, the network device 120 may send a RS to the terminal device 110-1 in a downlink. Similarly, the terminal device 110-1 may transmit a RS to the network device 120 in an uplink. Generally speaking, a RS is a signal sequence (also referred to as “RS sequence”) that is known by both the network device 120 and the terminal devices 110. For example, a RS sequence may be generated and transmitted by the network device 120 based on a certain rule and the terminal device 110-1 may deduce the RS sequence based on the same rule. For another example, a RS sequence may be generated and transmitted by the terminal device 110-1 based on a certain rule and the network device 120 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking, Positioning Reference Signal (PRS) and so on.

In addition to normal data communications, the network device 120 may transmit DCI via a PDCCH to the terminal device 110. The DCI may indicate resource allocation for data transmission in a DL or UL. Concurrently, a DMRS associated with the PDCCH may also be transmitted from the network device 120 to the terminal device 110. The DMRS may be used by the terminal device 110-1 for channel demodulation. Then, the terminal device 110-1 may attempt to blindly decode the DCI in a PDCCH in a search space which is associated with a control information set (CORESET). As used herein, a “CORESET” and/or a search space refers to a set of resource element groups (REGs) within which the terminal device attempts to blindly decode the DCI. A search space indicating the start time and a periodicity for monitoring a PDCCH in the CORESET may be indicated to the terminal device 110. In response to decoding the DCI successfully, the terminal device 110-1 may perform the UL and/or DL data transmission (for example, data transmission via PDSCH and/or Physical Uplink Shared Channel (PUSCH)) with the network device 120 accordingly.

The network device 120 may communicate data and control information to the terminal device 110-1 via a plurality of beams (also referred to as “DL beams”). The terminal device 110-1 may also communicate data and control information to the network device 120 via a plurality of beams (also referred to as “UL beams”). In 3GPP specifications for new radio (NR), a beam is also defined and indicated by parameters of a transmission configuration indicator. For example, there may be a transmission configuration indication (TCI) field in DCI. A value of the TCI field may be referred to as a “TCI codepoint”. A TCI codepoint may indicate one or more TCI states. Each TCI state contains parameters for configuring a quasi co-location (QCL) relationship between one or two DL and/or UL reference signals and the DMRS ports of the PDSCH, the DMRS ports of PDCCH, the DMRS ports of PUSCH, the DMRS ports of PUCCH, the SRS ports of a SRS resource or the CSI-RS ports of a CSI-RS resource.

In some embodiments, the communication between the network device 120 and the terminal device 110-1 may be within a same component carrier (CC) or within a same bandwidth part (BWP).

In this disclosure, the terms “time threshold”, “threshold” and “timing” can be used interchangeably. The terms “first threshold”, “first time threshold” and “threshold A” can be used interchangeably. The terms “second threshold”, “second time threshold” and “threshold B” can be used interchangeably. The terms “transmit”, “receive”, “transmission”, “reception”, “scheduling”, “schedule”, “buffering”, “buffer”, “detection”, “detecting”, “detect”, “monitor” and “monitoring” can be used interchangeably. The terms “predetermined”, “determined”, “configured”, “indicated”, “signaled” and “reported” can be used interchangeably. The terms “configuration”, “indication”, “information”, “signaling” and “parameter” can be used interchangeably. The terms “set”, “subset” and “group” can be used interchangeably. The terms “acknowledgement”, “positive acknowledgement”, “ACK”, “Hybrid automatic repeat request acknowledgement”, “HARQ-ACK”, “negative acknowledgement”, “NACK”, “NAK”, “ACK/NACK” and “ACK/NAK” can be used interchangeably.

In some embodiments, there may be a first time threshold H1 and/or a second time threshold H2 for the terminal device 110. For example, the first time threshold H1 and/or the second time threshold H2 may be predefined for the terminal device 110. For another example, the first time threshold H1 and/or the second time threshold H2 may be defined based on the capability of the terminal device 110. For another example, the first time threshold H1 and/or the second time threshold H2 may be configured for the terminal device via at least one of RRC, MAC CE and DCI. In some embodiments, the first time threshold H1 may be the same as or different from the second time threshold H2. In some embodiments, the first time threshold H1 and/or the second time threshold H2 may be the same as the threshold timeDurationForQCL or beamSwitchTiming as specified in TS 38.214 or TS 38.306.

In some embodiments, the first time threshold H1 may be a time duration for determining TCI state for PDSCH or for beam switching. In some embodiments, the first time threshold H1 may indicate a predetermined/configured time period. The predetermined/configured time period may be Xi ms/us/slots/symbols/sub-slot, where Xi is an integer. For example, 1≤ Xi≤336. For example, the predetermined time period Xi may be 7, 14 or 28 symbols, such as, 7, 14 or 28 symbols if the subcarrier spacing is 60 KHz and 14 or 28 symbols if the subcarrier spacing is 120 KHz. For another example, the predetermined time period Xi may be L slots, where L is an integer and L may be any one of {0, 1, 2, 3, 4, 5, 6, 7, 8}.

In some embodiments, the second time threshold H2 may be a time duration for application timing of an indicated/updated TCI state. In some embodiments, the second time threshold H2 may indicate a predetermined/configured time period. The predetermined/configured time period may be Yi ms/us/slots/symbols/sub-slot, where Yi is an integer. For example, 1≤ Yi≤336. For example, the predetermined time period Yi may be 7, 14 or 28 symbols, such as, 7, 14 or 28 symbols if the subcarrier spacing is 60 KHz and 14 or 28 symbols if the subcarrier spacing is 120 KHz. For another example, the predetermined time period Yi may be may be M slots, where M is an integer and M may be any one of {0, 1, 2, 3, 4, 5, 6, 7, 8}.

In some embodiments, the first time threshold H1 may indicate a predetermined/configured time period after the last symbol of a PDCCH (represented as “PDCCH P”) which schedules a PDSCH. For example, the predetermined/configured time period may be Xi ms/us/slots/symbols/sub-slot. For example, the predetermined time period may be 7, 14 or 28 symbols, such as, 7, 14 or 28 symbols if the subcarrier spacing is 60 KHz and 14 or 28 symbols if the subcarrier spacing is 120 KHz. For example, the predetermined/configured time period may depend on UE capability reported by the terminal device 110.

In some embodiments, there is an application timing for beam indication or TCI state(s) indication. In some embodiments, the application timing may be the first slot or first subslot that is at least X ms or Y symbols after the last symbol of the acknowledge of the joint or separate DL/UL beam indication. For example, Y may be integer, and 1<=Y<=336. In some embodiments, slot may include 12 or 14 symols. In some embodiments, subslot may include S symbols. S is integer, and 1<=S<=14. For example, S may be at least one of {2, 4, 7}. In some embodiments, the beam indication is indicated in a DCI in a PDCCH. For example, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the joint or separate DL/UL beam indication may be the acknowledge of the PDSCH scheduled by the DCI. For example, when the DCI schedules the PDSCH. In some embodiments, the acknowledge of the joint or separate DL/UL beam indication may be the acknowledge of the DCI. For example, when the DCI doesn't schedule a PDSCH.

In some embodiments, the terminal device may receive or detect a DCI (for example, represented as “DCI_t”) in a PDCCH, and the DCI indicates a joint DL/UL TCI state or a separate DL/UL TCI state or a DL TCI state or a UL TCI state or a pair of DL/UL TCI states. In some embodiments, the second time threshold H2 may indicate a predetermined/configured time period after the first or last symbol of the PDCCH or the first or last symbol of the acknowledge of the indication. In some embodiments, the indicated joint DL/UL TCI state or separate DL/UL TCI state or DL TCI state or UL TCI state or the pair of DL/UL TCI states may be applied to PDSCH and/or CORESET and/or PUSCH and/or PUCCH and/or uplink RS and/or downlink RS after the application timing or the second time threshold H2. For example, when a joint DL/UL TCI state is indicated in the DCI, the joint DL/UL TCI state may be applied to PDSCH and/or CORESET and/or PUSCH and/or PUCCH and/or uplink RS and/or downlink RS after the application timing or the second time threshold H2. For another example, when a DL TCI state is indicated in the DCI, the DL TCI state may be applied to PDSCH and/or CORESET and/or downlink RS after the application timing or the second time threshold H2. For another example, when an UL TCI state is indicated in the DCI, the UL TCI state may be applied to PUSCH and/or PUCCH and/or uplink RS after the application timing or the second time threshold H2. For another example, when a pair of DL/UL TCI states are indicated in the DCI, the DL TCI state may be applied to PDSCH and/or CORESET and/or downlink RS after the application timing or the second time threshold H2, and the UL TCI state may be applied to PUSCH and/or PUCCH and/or uplink RS after the application timing or the second time threshold H2.

In some embodiments, the terminal device 110-1 may receive an indication to indicate a downlink TCI state (or a beam or a set of QCL parameters), and the source reference signal(s) in the TCI state provides QCL information at least for reception on PDSCH and all of CORESETs in a component carrier (CC). For example, the PDSCH is dedicated or UE-specific.

In some embodiments, the terminal device 110-1 may receive an indication to indicate an uplink TCI state (or a beam or a spatial relation), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific.

In some embodiments, the terminal device 110-1 may receive an indication to indicate a joint TCI state (or a beam or a set of QCL parameters), and the TCI state refers to at least a common source reference signal used for determining both the downlink QCL information and the uplink transmission spatial filter.

In some embodiments, the terminal device 110-1 may receive an indication to indicate a downlink TCI state (or a beam or a set of QCL parameters) and an uplink TCI state (or a beam or a spatial relation), and the source reference signal(s) in the DL TCI state provides QCL information at least for reception on PDSCH and all of CORESETs in a component carrier (CC), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific. For another example, the PDSCH is dedicated or UE-specific.

In some embodiments, the terminal device 110-1 may be configured with more than one (For example, represented as M, M is positive integer. For example, M may be 2 or 3 or 4) downlink TCI states, and/or the terminal device 110-1 may receive an indication to indicate one of the M TCI states, and the source reference signal(s) in the one of the M TCI states or in the indicated one TCI state provides QCL information at least for reception on PDSCH and/or a subset of CORESETs in a CC. For example, the PDSCH is dedicated or UE-specific.

In some embodiments, the terminal device 110-1 may be configured with more than one (For example, represented as N, N is positive integer. For example, N may be 2 or 3 or 4) uplink TCI states, and/or the terminal device 110-1 may receive an indication to indicate one of the N TCI states, and the source reference signal(s) in the one of the N TCI states or in the indicated one TCI state provides a reference for determining uplink transmission spatial filter at least for dynamic grant or configured grant based PUSCH, and/or a subset of PUCCH resources in a CC. For example, the PUCCH is dedicated or UE-specific.

In some embodiments, the terminal device 110-1 may be configured with more than one (For example, represented as M, M is positive integer. For example, M may be 2 or 3 or 4) joint DL/UL TCI states, and/or receive an indication to indicate one from the M joint TCI states, and each one of the M TCI states or the indicated one TCI state refers to at least a common source reference signal used for determining both the downlink QCL information and the uplink transmission spatial filter.

In some embodiments, the terminal device 110-1 may be configured with more than one (For example, represented as M, M is positive integer. For example, M may be 2 or 3 or 4) downlink TCI states and the terminal device 110-1 may be configured with more than one (For example, represented as N, N is positive integer. For example, N may be 2 or 3 or 4) uplink TCI states, and/or the terminal device 110-1 may receive an indication to indicate one from the M downlink TCI states and one from the N uplink TCI states, and the source reference signal(s) in each one of the M DL TCI states or the indicated one DL TCI state provides QCL information at least for reception on PDSCH and/or a subset of CORESETs in a component carrier (CC), and the source reference signal(s) in each one of the N TCI states or in the indicated one UL TCI state provides a reference for determining uplink transmission spatial filter at least for dynamic grant or configured grant based PUSCH, and/or a subset of PUCCH resources in a CC. For example, the PUCCH is dedicated or UE-specific. For another example, the PDSCH is dedicated or UE-specific.

In the following, DCI_t may be used to describe the DCI for joint DL/UL TCI state indication or for separate DL/UL TCI state indication. In the following, the terms “DCI”, “PDCCH”, “DCI_t”, “DCI for joint DL/UL TCI state indication”, “DCI for separate DL/UL TCI state indication”, “DCI for DL TCI state indication”, “DCI for UL TCI state indication”, “PDCCH for joint DL/UL TCI state indication”, “PDCCH for separate DL/UL TCI state indication”, “PDCCH for DL TCI state indication”, “PDCCH for UL TCI state indication”, “DCI for TCI state indication” and “PDCCH for TCI state indication” can be used interchangeably.

In some embodiments, a DCI may be used for indicating a TCI state for joint DL/UL TCI state indication or for separate DL/UL TCI state indication. And the DCI may schedule a PDSCH (for example, DCI format 1_1 and format 1_2). In some embodiments, the HARQ of the PDSCH scheduled by the DCI can be used as an ACK for the DCI. For example, the DCI may be DCI_t.

In some embodiments, a DCI may be used for indicating a TCI state for joint DL/UL TCI state indication or for separate DL/UL TCI state indication. And the DCI may not schedule a PDSCH (for example, DCI format 1_1 and format 1_2). In some embodiments, a HARQ of the DCI may be introduced to indicate whether the DCI or the TCI state indication is successful. For example, the DCI may be DCI_t.

In some embodiments, if decoding of DCI_t or decoding of the PDSCH scheduled by DCI_t is ACK, the indicated TCI state may be applied for PDSCH and/or all or subset of CORESETs after an application timing.

In some embodiments, HARQ mechanism of semi persistent scheduling (SPS) PDSCH release can be reused for HARQ of DCI_t, and there is no PDSCH scheduling in the DCI_t.

In some embodiments, a DCI (for example, DCI_t) may be used for indicating one or more TCI states. For example, the one or more TCI states are for joint DL/UL TCI state indication or for separate DL/UL TCI state indication. And the DCI may not schedule a PDSCH (for example, DCI format 1_1 and format 1_2). In some embodiments, upon a successful reception/decoding of the DCI, the terminal device 110-1 may report an ACK. In some embodiments, upon a failed reception/decoding of the DCI, the terminal device 110-1 may report a NACK. For example, the ACK and/or NACK may be reported in a physical uplink control channel (PUCCH) or a physical uplink shared channel (PUSCH). In some embodiments, the terminal device 110-1 may be configured with a type of HARQ codebook. For example, the type may be at least one of Type 1 (for example, semi-static), Type 2 (for example, dynamic) and Type 3 (one shot feedback). For example, the type may be configured via at least one of RRC, MAC CE and DCI. In some embodiments, the DCI is received/detected in a PDCCH.

In some embodiments, for a HARQ-ACK information bit, the terminal device 110-1 generates a positive acknowledgement (ACK) if the terminal device 110-1 detects a DCI format that provides a SPS PDSCH release or a beam indication with CS-RNTI scrambled or correctly decodes a transport block, and generates a negative acknowledgement (NACK) if the terminal device 110-1 does not correctly decode the transport block. A HARQ-ACK information bit value of 0 represents a NACK while a HARQ-ACK information bit value of 1 represents an ACK.

In some embodiments, the terminal device 110-1 may be configured/indicated with a first TCI state for reception of PDSCH and/or all or a subset of CORESETs. And the terminal device 110-1 may receive or detect a first PDCCH with the first TCI state, and the PDCCH is in a first CORESET. The terminal device 110-1 may be indicated with a second TCI state in the DCI received or detected in the first PDCCH. In some embodiments, the DCI in the first PDCCH may schedule or may not schedule a first PDSCH or a first PUSCH. In some embodiments, the terminal device 110-1 may report the decoding result or HARQ-ACK information for at least one of the DCI or the first PDCCH or the first PDSCH to the network device 120. For example, the decoding result or the HARQ-ACK information may be transmitted/reported in a PUCCH or in a second PUSCH. In some embodiments, after the application timing or after the second time threshold H2, the terminal device 110-1 may receive PDSCH and/or all or the subset of CORESETs with the second TCI state. For example, the terminal device 110-1 may receive a second PDCCH with the second TCI state, and the second PDCCH is in a second CORESET. For another example, the terminal device 110-1 may receive a second PDCCH with the second TCI state, and the second PDCCH is in the first CORESET.

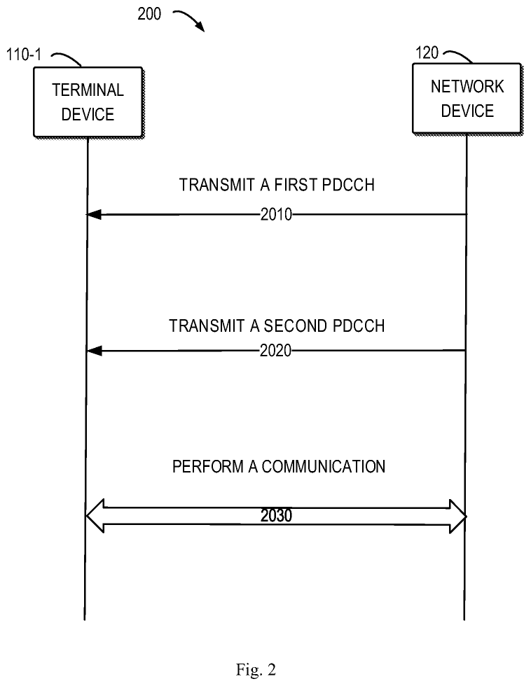

FIG. 2 illustrates a signaling chart for communication between network device and terminal device in accordance with some embodiments of the present disclosure. For the purpose of discussion, the process 200 will be described with reference to FIG. 1. The process 200 may involve the network device 120 and the terminal device 110-1 as shown in FIG. 1.

In some embodiments, the terminal device 110-1 may be configured/indicated with a third TCI for reception of PDSCH and/or all or a subset of CORESETs. For example, the third TCI is applied at the time (or in the slot/subslot) for a first PDCCH reception. In some embodiments, the network device 120 transmits 2010 the first PDCCH to the terminal device 110-1. And the terminal device 110-1 may receive or detect the first PDCCH with the third TCI. For example, the first PDCCH is in a first CORESET. In some embodiments, the terminal device 110-1 may be indicated with a first TCI in a first DCI received or detected in the first PDCCH. In some embodiments, the first DCI may schedule a PDSCH or may not schedule a PDSCH. In some embodiments, the terminal device 110-1 may report the decoding result or a first HARQ-ACK information for at least one of the first DCI or the first PDCCH or the PDSCH scheduled by the first DCI to the network device 120. For example, the decoding result or the first HARQ-ACK information may be transmitted/reported in a first PUCCH or in a first PUSCH. In some embodiments, the terminal device 110-1 may be configured/indicated with a fourth TCI for transmission of PUSCH and/or all or a subset of PUCCH. For example, the fourth TCI is applied at the time (or in the slot/subslot) for the first PUCCH or the first PUSCH transmission. For example, the terminal device 110-1 may transmit the first PUCCH or the first PUSCH with the fourth TCI.

In some embodiments, the network device 120 transmits 2020 a second PDCCH to the terminal device 110-1. In some embodiments, the terminal device 110-1 may receive or detect the second PDCCH with a fifth TCI or with the third TCI. For example, the second PDCCH is in the first CORESET. For another example, the second PDCCH is in a second CORESET, wherein the configuration for first CORESET and the configuration for the second CORESET are different. In some embodiment, the terminal device 110-1 may be indicated with a second TCI in a second DCI received or detected in the second PDCCH. In some embodiments, the second DCI may schedule or may not schedule a PDSCH. In some embodiments, the terminal device 110-1 may report the decoding result or a second HARQ-ACK information for at least one of the second DCI or the second PDCCH or the PDSCH scheduled by the second DCI to the network device 120. For example, the decoding result or the second HARQ-ACK information may be transmitted/reported in a second PUCCH or in a second PUSCH. For example, the terminal device 110-1 may transmit the second PUCCH or the second PUSCH with the fourth TCI or with a sixth TCI. In some embodiments, the terminal device 110-1 may be configured/indicated with a fifth TCI for reception of PDSCH and/or all or a subset of CORESETs. For example, the fifth TCI is applied at the time (or in the slot/subslot) for the second PDCCH reception. In some embodiments, the terminal device 110-1 may be configured/indicated with a sixth TCI for transmission of PUSCH and/or all or a subset of PUCCH. For example, the sixth TCI is applied at the time (or in the slot/subslot) for the second PUCCH or the second PUSCH transmission.

In some embodiments, the first TCI may be a first DL TCI state or a first DL TCI state in a first pair of DL/UL TCI states, and the second TCI may be a second DL TCI state or a second DL TCI state in a second pair of DL/UL TCI states. In some embodiments, the first TCI may be a first UL TCI state or a first UL TCI state in a first pair of DL/UL TCI states, and the second TCI may be a second UL TCI state or a second UL TCI state in a second pair of DL/UL TCI states. In some embodiments, the first DL TCI state may be different from the second DL TCI state. In some embodiments, the first UL TCI state may be different from the second UL TCI state. In some embodiments, the first pair of DL/UL TCI states may be different from the second pair of DL/UL TCI states. In some embodiments, the first TCI may be a first joint DL/UL TCI state, and the second TCI may be a second joint DL/UL TCI state. In some embodiments, the first joint DL/UL TCI state may be different from the second joint DL/UL TCI state.

In some embodiments, the third TCI may be a third joint DL/UL TCI state. In some embodiments, the third TCI may be a third DL TCI state. In some embodiments, the third TCI may be a third DL TCI state in a third pair of DL/UL TCI states. In some embodiments, the fifth TCI may be a fifth joint DL/UL TCI state. In some embodiments, the fifth TCI may be a fourth DL TCI state. In some embodiments, the fifth TCI may be a fourth DL TCI state in a fifth pair of DL/UL TCI states.

In some embodiments, the fourth TCI may be a fourth joint DL/UL TCI state. In some embodiments, the fourth TCI may be a third UL TCI state. In some embodiments, the fourth TCI may be a third UL TCI state in a fourth pair of DL/UL TCI states. In some embodiments, the sixth TCI may be a sixth joint DL/UL TCI state. In some embodiments, the sixth TCI may be a fourth UL TCI state. In some embodiments, the sixth TCI may be a fourth UL TCI state in a sixth pair of DL/UL TCI states.

In some embodiments, the third DL TCI state or the fourth DL TCI state may be same or different from the first DL TCI state or the second DL TCI state. In some embodiments, the third DL TCI state may be same or different from the fourth DL TCI state. In some embodiments, the third joint DL/UL TCI state or the fourth joint DL/UL TCI state or the fifth joint DL/UL TCI state or the sixth joint DL/UL TCI state may be same or different from the first joint DL/UL TCI state or the second joint DL/UL TCI state. In some embodiments, the third pair of DL/UL TCI states or the fourth pair of DL/UL TCI states or the fifth pair of DL/UL TCI states or the sixth pair of DL/UL TCI states may be same or different from the second pair or DL/UL TCI states or the first pair of DL/UL TCI states.

In some embodiments, the first PDCCH may start or end earlier or no later than the second PDCCH. For example, the first or last symbol of the first PDCCH may be earlier or no later than the first or last symbol of the second PDCCH.

In some embodiments, the time and/or frequency resource for the first PUCCH or the first PUSCH is different from the time and/or frequency resource for the second PUCCH or the second PUSCH. In some embodiments, the first PUCCH or the first PUSCH may be in a slot or in a subslot (e.g. represented as n1). In some embodiments, the second PUCCH or the second PUSCH may be in a slot or in a subslot (e.g. represented as n2). For example, n1 is different from n2. For example, n1 is later or no earlier than n2. For another example, n1 is earlier or no later than n2. In some embodiments, the first PUCCH or the first PUSCH may start or end later or no earlier than the second PUCCH or the second PUSCH. For example, the first or last symbol of the first PUCCH or the first PUSCH may be later or no earlier than the first or last symbol of the second PUCCH or the second PUSCH. In some embodiments, the first PUCCH or the first PUSCH may start or end earlier or no later than the second PUCCH or the second PUSCH. For example, the first or last symbol of the first PUCCH or the first PUSCH may be earlier or no later than the first or last symbol of the second PUCCH or the second PUSCH.

In some embodiments, the first application timing for the first TCI may be the first one slot or the first one subslot after X ms or Y symbols from the last symbol of the first PUCCH or the first PUSCH. In some embodiments, the second application timing for the second TCI may be the first one slot or the first one subslot after X ms or Y symbols from the last symbol of the second PUCCH or the second PUSCH. In some embodiments, the slot or the subslot for the first application timing for the first TCI may be same as the slot or the subslot for second application timing for the second TCI. In some embodiments, the first HARQ-ACK information corresponding to the first DCI or the PDSCH scheduled by the first DCI may be ACK. In some embodiments, the second HARQ-ACK information corresponding to the second DCI or the PDSCH scheduled by the second DCI may be ACK. In some embodiments, the first HARQ-ACK information and the second HARQ-ACK information may be transmitted in different time and/or frequency resources. For example, the time/frequency resources may be PUSCH resource or PUCCH resource.

In some embodiments, the terminal device 110-1 may receive PDSCH and/or all or the subset of CORESETs with the second TCI from the first one slot or the first one subslot or after/from the application timing. terminal device 110-1 In some embodiments, the terminal device 110-1 may transmit PUSCH and/or all or the subset of PUCCH with the second TCI from the first one slot or the first one subslot or after/from the application timing.

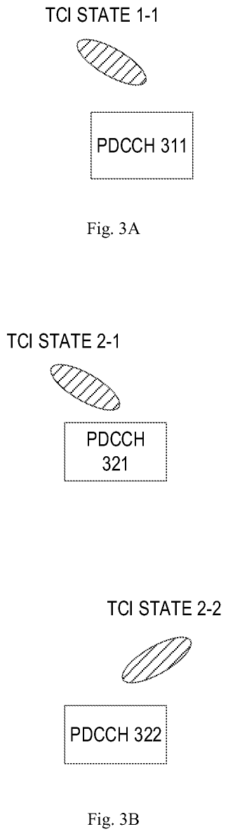

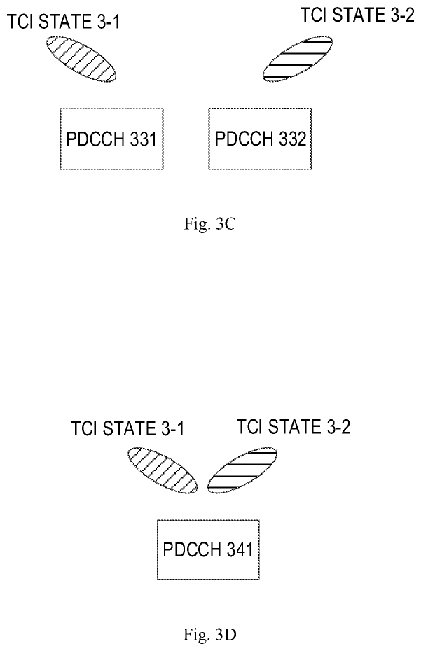

FIGS. 3A-3D illustrate examples for configuration of one or two PDCCHs for the terminal device 110. And the one or two PDCCHs are applied for a same scheduling of a communication between the network device 120 and the terminal device 110-1 terminal device 110. For example, the communication may be at least one of PDCCH, PDSCH, PUSCH, PUCCH, downlink RS and uplink RS.

In the example of FIG. 3A, TCI state 1-1 may be configured to the terminal device 110-1 for monitoring a PDCCH in a CORESET/search space. As shown in FIG. 3A, the terminal device 110-1 may receive PDCCH 311 with TCI state 1-1 for a scheduling of a communication. In some embodiments, there may be one or two or more TCI states or spatial relation info indicated in PDCCH 311 for the scheduling of communication.

In the example of FIG. 3B, TCI state 2-1 may be configured to the terminal device 110-1 for monitoring a first PDCCH in a first CORESET/search space, and TCI state 2-2 may be configured to the terminal device 110-1 for monitoring a second PDCCH in a second CORESET/search space. For example, the scheduling of communication in the first PDCCH and the scheduling of communication in the second PDCCH may be independent/separate. As shown in FIG. 3B, the terminal device 110-1 may receive PDCCH 321 with TCI state 2-1 for a first scheduling of communication. In some embodiments, there may be one or two or more TCI states or spatial relation info indicated in PDCCH 321 for the first scheduling of communication. Also as shown in FIG. 3B, the terminal device 110-1 may receive PDCCH 322 with TCI state 2-2 for a second scheduling of communication. In some embodiments, there may be one or two or more TCI states or spatial relation info indicated in PDCCH 322 for the second scheduling of communication. In some embodiments, the PDCCH 321 and PDCCH 322 may be non-overlapping or partial overlapping or full overlapping in time and/or frequency domain. In some embodiments, the first communication and the second communication may be non-overlapping or partial overlapping or full overlapping in time and/or frequency domain.

In the example of FIG. 3C, TCI state 3-1 may be configured to the terminal device 110-1 for monitoring a first PDCCH in a first CORESET/search space, and TCI state 3-2 may be configured to the terminal device 110-1 for monitoring a second PDCCH in a second CORESET/search space, and the first CORESET/search space and the second CORESET/search space are configured to be linked according to some embodiments in this disclosure. For example, the first PDCCH and the second PDCCH are applied to schedule same communication between the network device 120 and the terminal device 110-1. For another example, the payload or information in the first PDCCH and the second PDCCH is same. As shown in FIG. 3C, the terminal device 110-1 may receive PDCCH 331 with TCI state 3-1 for a scheduling of a communication and the terminal device 110-1 may receive PDCCH 332 with TCI state 3-2 for the same scheduling of the communication. In some embodiments, there may be one or two or more TCI states or spatial relation info indicated in PDCCH 331 and in PDCCH 332 for the scheduling of communication.

In the example of FIG. 3D, TCI state 4-1 and TCI state 4-2 may be configured to the terminal device 110-1 for monitoring a PDCCH in a CORESET/search space. As shown in FIG. 3D, the terminal device 110-1 may receive PDCCH 341 with TCI state 4-1 and TCI state 4-2 for a scheduling of a communication. In some embodiments, there may be one or two or more TCI states or spatial relation info indicated in PDCCH 341 for the scheduling of communication.

The terminal device 110-1 performs 2030 a communication with the network device 120 with the second TCI after a period of time or after/from the application timing, if the reception of the second PDCCH is later than the reception of the first PDCCH.

In an example embodiment, the terminal device 110-1 may transmit a second hybrid automatic repeat request (HARQ) feedback corresponding to a second scheduling based on the second PDCCH. The terminal device 110-1 may transmit a first HARQ feedback corresponding to a first scheduling based on the first PDCCH. In some embodiments, if the transmission of the first HARQ feedback is later than or no earlier than the transmission of the second HARQ feedback, the terminal device 110-1 can perform the communication with the network device 120 with the second TCI after the period of time or after/from the application timing. The first scheduling can be a PDSCH scheduling based on the first PDCCH. The second scheduling can be a TCI state or a pair of TCI state indication without PDSCH scheduling based on the second PDCCH. In other embodiments, the second scheduling can be a PDSCH scheduling based on the second PDCCH.

Alternatively, if the first TCI state is applicable and the second TCI state is inapplicable, the terminal device 110-1 may perform the communication with the network device with the first TCI state.

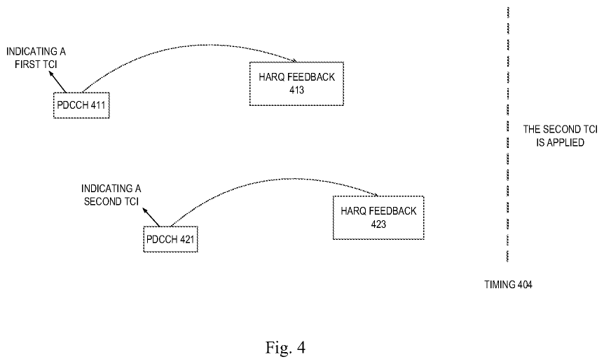

FIG. 4 illustrates a schematic diagram of applying beam(s)/TCI state(s) according to some example embodiments. As shown in FIG. 4, the terminal device 110-1 may receive or detect a PDCCH 411, and the DCI detected in the PDCCH 411 may indicate a first TCI. And the PDCCH 411 or the DCI detected in the PDCCH 411 may or may not schedule a PDSCH. And the terminal device 110-1 may report HARQ feedback 413 for the PDSCH scheduled by the PDCCH 411 or for the DCI in the PDCCH 411 to the network device 120. For example, the HARQ feedback 413 is ACK. The terminal device 110-1 may receive or detect a PDCCH 421, and the DCI detected in the PDCCH 421 may indicate a second TCI. And the PDCCH 421 or the DCI detected in the PDCCH 421 may or may not schedule a PDSCH. And the terminal device 110-1 may report HARQ feedback 423 for the PDSCH scheduled by the PDCCH 421 or for the DCI in the PDCCH 421 to the network device 120. For example, the HARQ feedback 423 is ACK. For example, the terminal device 110-1 may be configured/indicated with a third TCI for reception of PDSCH and/or all or a subset of CORESETs. For example, the third TCI is applied at the time (or in the slot/subslot) for the PDCCH 411 reception. For example, the terminal device 110-1 may receive the PDCCH 411 with the third TCI. For example, the terminal device 110-1 may receive the PDCCH 421 with the third TCI. For another example, the terminal device 110-1 may receive the PDCCH 421 with a fourth TCI, wherein the fourth TCI may be configured/indicated to the terminal device 110-1 for reception of PDSCH and/or all or a subset of CORESETs at the time (or in the slot/subslot) for PDCCH 421 reception. For example, the third TCI may be same or different from the fourth TCI. In some embodiments, the application timing for the first TCI and the application timing for the second TCI may be same, for example, TIMING 404 as shown in FIG. 4. In this situation, there is more than one applicable beam/TCI state(s) within one slot or subslot. The number of applicable beam/TCI state(s) can be any integer number. It should be noted that the number of PDCCHs are only examples not limitations. In this case, the beam/TCI which corresponds to the latest or later PDCCH is applied. For example, as shown in FIG. 4, the beam/TCI indicated in the PDCCH 421 is applied after or from TIMING 404. The terminal device 110-1 can perform the communication with the network device 120 with the second TCI after or from the timing 404. In this way, it can avoid ambiguity for the network device and the terminal device.

In some embodiments, the terminal device 110-1 may be configured/indicated with a third TCI for reception of PDSCH and/or all or a subset of CORESETs. For example, the third TCI is applied at the time (or in the slot/subslot) for a first PDCCH reception. In some embodiments, the network device 120 may transmit the first PDCCH to the terminal device 110-1. And the terminal device 110-1 may receive or detect the first PDCCH with the third TCI. For example, the first PDCCH is in a first CORESET. In some embodiments, the terminal device 110-1 may be indicated with a first TCI in a first DCI received or detected in the first PDCCH. In some embodiments, the first DCI may schedule a PDSCH or may not schedule a PDSCH. In some embodiments, the terminal device 110-1 may report the decoding result or a first HARQ-ACK information for at least one of the first DCI or the first PDCCH or the PDSCH scheduled by the first DCI to the network device 120. For example, the decoding result or the first HARQ-ACK information may be transmitted/reported in a first PUCCH or in a first PUSCH. In some embodiments, the terminal device 110-1 may be configured/indicated with a fourth TCI for transmission of PUSCH and/or all or a subset of PUCCH. For example, the fourth TCI is applied at the time (or in the slot/subslot) for the first PUCCH or the first PUSCH transmission. For example, the terminal device 110-1 may transmit the first PUCCH or the first PUSCH with the fourth TCI.

In some embodiments, the network device 120 may transmit a second PDCCH to the terminal device 110-1. In some embodiments, the terminal device 110-1 may receive or detect the second PDCCH with a fifth TCI or with the third TCI. For example, the second PDCCH is in the first CORESET. For another example, the second PDCCH is in a second CORESET, wherein the configuration for first CORESET and the configuration for the second CORESET are different. In some embodiment, the terminal device 110-1 may be indicated with a second TCI in a second DCI received or detected in the second PDCCH. In some embodiments, the second DCI may not schedule a PDSCH. In some embodiments, the terminal device 110-1 may report the decoding result or a second HARQ-ACK information for the second DCI or the second PDCCH to the network device 120. For example, the decoding result or the second HARQ-ACK information may be transmitted/reported in a second PUCCH or in a second PUSCH. For example, the terminal device 110-1 may transmit the second PUCCH or the second PUSCH with the fourth TCI or with a sixth TCI. In some embodiments, the terminal device 110-1 may be configured/indicated with a fifth TCI for reception of PDSCH and/or all or a subset of CORESETs. For example, the fifth TCI is applied at the time (or in the slot/subslot) for the second PDCCH reception. In some embodiments, the terminal device 110-1 may be configured/indicated with a sixth TCI for transmission of PUSCH and/or all or a subset of PUCCH. For example, the sixth TCI is applied at the time (or in the slot/subslot) for the second PUCCH or the second PUSCH transmission.

In some embodiments, the first TCI may be a first DL TCI state or a first DL TCI state in a first pair of DL/UL TCI states, and the second TCI may be a second DL TCI state or a second DL TCI state in a second pair of DL/UL TCI states. In some embodiments, the first TCI may be a first UL TCI state or a first UL TCI state in a first pair of DL/UL TCI states, and the second TCI may be a second UL TCI state or a second UL TCI state in a second pair of DL/UL TCI states. In some embodiments, the first DL TCI state may be different from the second DL TCI state. In some embodiments, the first UL TCI state may be different from the second UL TCI state. In some embodiments, the first pair of DL/UL TCI states may be different from the second pair of DL/UL TCI states. In some embodiments, the first TCI may be a first joint DL/UL TCI state, and the second TCI may be a second joint DL/UL TCI state. In some embodiments, the first joint DL/UL TCI state may be different from the second joint DL/UL TCI state.

In some embodiments, the third TCI may be a third joint DL/UL TCI state. In some embodiments, the third TCI may be a third DL TCI state. In some embodiments, the third TCI may be a third DL TCI state in a third pair of DL/UL TCI states. In some embodiments, the fifth TCI may be a fifth joint DL/UL TCI state. In some embodiments, the fifth TCI may be a fourth DL TCI state. In some embodiments, the fifth TCI may be a fourth DL TCI state in a fifth pair of DL/UL TCI states.

In some embodiments, the fourth TCI may be a fourth joint DL/UL TCI state. In some embodiments, the fourth TCI may be a third UL TCI state. In some embodiments, the fourth TCI may be a third UL TCI state in a fourth pair of DL/UL TCI states. In some embodiments, the sixth TCI may be a sixth joint DL/UL TCI state. In some embodiments, the sixth TCI may be a fourth UL TCI state. In some embodiments, the sixth TCI may be a fourth UL TCI state in a sixth pair of DL/UL TCI states.

In some embodiments, the third DL TCI state or the fourth DL TCI state may be same or different from the first DL TCI state or the second DL TCI state. In some embodiments, the third DL TCI state may be same or different from the fourth DL TCI state. In some embodiments, the third joint DL/UL TCI state or the fourth joint DL/UL TCI state or the fifth joint DL/UL TCI state or the sixth joint DL/UL TCI state may be same or different from the first joint DL/UL TCI state or the second joint DL/UL TCI state. In some embodiments, the third pair of DL/UL TCI states or the fourth pair of DL/UL TCI states or the fifth pair of DL/UL TCI states or the sixth pair of DL/UL TCI states may be same or different from the second pair or DL/UL TCI states or the first pair of DL/UL TCI states.

In some embodiments, the first PDCCH may start or end earlier or no later than the second PDCCH. For example, the first or last symbol of the first PDCCH may be earlier or no later than the first or last symbol of the second PDCCH.

In some embodiments, the time and/or frequency resource for the first PUCCH or the first PUSCH is different from the time and/or frequency resource for the second PUCCH or the second PUSCH. In some embodiments, the first PUCCH or the first PUSCH may be in a slot or in a subslot (e.g. represented as n1). In some embodiments, the second PUCCH or the second PUSCH may be in a slot or in a subslot (e.g. represented as n2). For example, n1 is different from n2. For example, n1 is later or no earlier than n2. In some embodiments, the first PUCCH or the first PUSCH may start or end later or no earlier than the second PUCCH or the second PUSCH. For example, the first or last symbol of the first PUCCH or the first PUSCH may be later or no earlier than the first or last symbol of the second PUCCH or the second PUSCH.

In some embodiments, the first application timing for the first TCI may be the first one slot or the first one subslot after X ms or Y symbols from the last symbol of the first PUCCH or the first PUSCH. In some embodiments, the second application timing for the second TCI may be the first one slot or the first one subslot after X ms or Y symbols from the last symbol of the second PUCCH or the second PUSCH. In some embodiments, the slot or the subslot for the first application timing for the first TCI may be later than the slot or the subslot for second application timing for the second TCI. In some embodiments, the first HARQ-ACK information corresponding to the first DCI or the PDSCH scheduled by the first DCI may be ACK. In some embodiments, the second HARQ-ACK information corresponding to the second DCI or the PDSCH scheduled by the second DCI may be ACK. In some embodiments, the first HARQ-ACK information and the second HARQ-ACK information may be transmitted in different time and/or frequency resources. For example, the time/frequency resources may be PUSCH resource or PUCCH resource.

In some embodiments, the terminal device 110-1 may receive PDSCH and/or all or the subset of CORESETs with the second TCI from the first one slot or the first one subslot or after/from the second application timing. In some embodiments, the terminal device 110-1 may transmit PUSCH and/or all or the subset of PUCCH with the second TCI from the first one slot or the first one subslot or after/from the second application timing. In some embodiments, the terminal device 110-1 may receive PDSCH and/or all or the subset of CORESETs with the second TCI from the first one slot or the first one subslot or after/from the first application timing. For example, the first TCI is not applied after or from the first application timing. In some embodiments, the terminal device 110-1 may transmit PUSCH and/or all or the subset of PUCCH with the second TCI from the first one slot or the first one subslot or after/from the first application timing. For example, the first TCI is not applied after or from the first application timing.

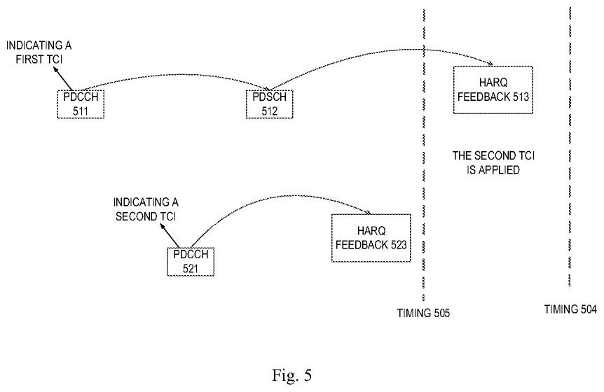

In some embodiments, the terminal device 110-1 may receive a first PDCCH with data assignment. The terminal device 110-1 may also receive a second PDCCH without data assignment. As shown in FIG. 5, the terminal device 110-1 may receive or detect a PDCCH 511, and the DCI detected in the PDCCH 511 may indicate a first TCI. And the PDCCH 511 or the DCI detected in the PDCCH 511 may schedule a PDSCH 512. And the terminal device 110-1 may report HARQ feedback 513 for the PDSCH 512 to the network device 120. For example, the HARQ feedback 513 is ACK. The terminal device 110-1 may receive or detect a PDCCH 521, and the DCI detected in the PDCCH 421 may indicate a second TCI. The PDCCH 521 or the DCI detected in the PDCCH 521 may not schedule a PDSCH. The terminal device 110-1 may report HARQ feedback 523 for the DCI in the PDCCH 521 to the network device 120. For example, the HARQ feedback 523 is ACK. For example, the terminal device 110-1 may be configured/indicated with a third TCI for reception of PDSCH and/or all or a subset of CORESETs. For example, the third TCI is applied at the time (or in the slot/subslot) for the PDCCH 511 reception. For example, the terminal device 110-1 may receive the PDCCH 511 with the third TCI. For example, the terminal device 110-1 may receive the PDCCH 521 with the third TCI. For another example, the terminal device 110-1 may receive the PDCCH 521 with a fourth TCI, wherein the fourth TCI may be configured/indicated to the terminal device 110-1 for reception of PDSCH and/or all or a subset of CORESETs at the time (or in the slot/subslot) for PDCCH 521 reception. For example, the third TCI may be same or different from the fourth TCI.

In some embodiments, the PDCCH 511 may start or end earlier or no later than the PDCCH 521. For example, the first or last symbol of the PDCCH 511 may be earlier or no later than the first or last symbol of the PDCCH 521. In some embodiments, the PUCCH or PUSCH resource for the HARQ feedback 513 may start or end later or no earlier than the PUCCH or PUSCH resource for the HARQ feedback 523. In some embodiments, the PUCCH or PUSCH resource for the HARQ feedback 513 may be in a slot or in a subslot (e.g. represented as n1). In some embodiments, the PUCCH or PUSCH resource for the HARQ feedback 523 may be in a slot or in a subslot (e.g. represented as n2). For example, n1 is different from n2. For example, n1 is later or no earlier than n2. In some embodiments, the first or last symbol of the PUCCH or PUSCH resource for the HARQ feedback 513 may be later or no earlier than the first or last symbol of the PUCCH or PUSCH resource for the HARQ feedback 523. In some embodiments, the application timing for the first TCI is TIMING 504 as shown in FIG. 4, and the application timing for the second TCI is TIMING 505 as shown in FIG. 4. For example, the TIMING 505 is earlier than the TIMING 504.

In some embodiments, the terminal device 110-1 may receive PDSCH and/or all or the subset of CORESETs with the second TCI from TIMING 505. In some embodiments, the terminal device 110-1 may transmit PUSCH and/or all or the subset of PUCCH with the second TCI from TIMING 505. In some embodiments, the terminal device 110-1 may still receive PDSCH and/or all or the subset of CORESETs with the second TCI from TIMING 504. For example, the first TCI is not applied from TIMING 504. In some embodiments, the terminal device 110-1 may still transmit PUSCH and/or all or the subset of PUCCH with the second TCI from TIMING 504. For example, the first TCI is not applied from TIMING 504.

Since the PDCCH 521 does not schedule the PDSCH and the PDCCH 511 schedules the PDSCH 512, the transmission of the HARQ feedback 523 may be earlier than the transmission of the HARQ feedback 513. The terminal device 110-1 may apply the second TCI after the timing 505. In this case, the terminal device 110-1 may not apply the first TCI after the timing 504. In other words, the first TCI may be ignored by the terminal device 110-1. In this way, it can reduce latency and avoid unnecessary beam switching.

Alternatively, if the second TCI indicated in the PDCCH 521 is not applicable or there is no applied TCI state indicated in the PDCCH 521 and the first TCI indicated in the PDCCH 511 is applicable, the terminal device 110-1 may apply the first TCI, for example, from TIMING 504. For example, the HARQ feedback 523 is NACK, then the TCI indicated in the PDCCH 521 may not be applicable.

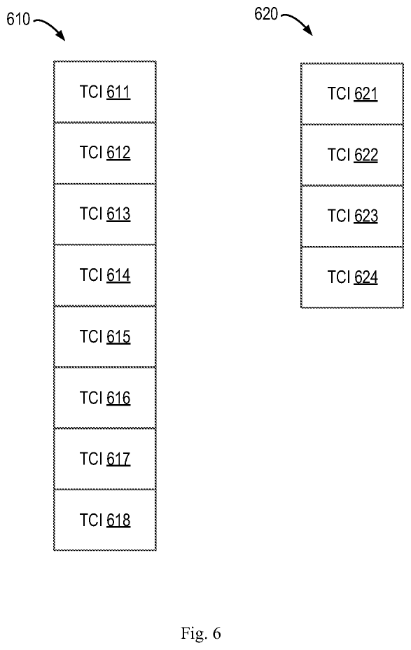

In some embodiments, the terminal device 110-1 may receive DCI in different DCI formats. For example, the terminal device 110-1 may receive DCI in DCI format 1_2 and DCI format 1_1. When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, for example, as described in clause 6.1.3.14 and 6.1.3.24 of [10, TS38.321], only the first S-1 activated codepoints are applied for DCI format 1_2, and the remaining codepoint (for example, the first or last codepoint) for DCI format 1_2 indicates the latest or current applied TCI state(s) (or latest or current indicated TCI state(s) in DCI format 1_1 or the TCI state(s) indicated in DCI format 1_1 in latest PDCCH before or earlier or no later than the PDCCH with DCI format 1_2). For example, as shown in FIG. 6, the DCI format 1_1 may include 3 bits in TCI field. In this situation, the DCI format 1_1 has up to 8 codepoints which are shown as TCI 611, TCI 612, TCI 613, TCI 614, TCI 615, TCI 616, TCI 617 and TCI 618. The DCI format 1_2 may include 2 bits in TCI field. In this situation, the DCI format 1_2 has up to 4 codepoints which are shown as TCI 621, TCI 622, TCI 623 and TCI 624. In this case, 3 codepoints for the DCI format 1_2 can be indicated or applied and the remaining codepoint for DCI format 1_2 may indicate one of: the latest or current applied TCI state(s), the latest or current indicated TCI state(s) in DCI format 1_1, or the TCI state(s) indicated in DCI format 1_1 in latest PDCCH before or earlier or no later than the PDCCH with DCI format 1_2. For example, TCI 621, TCI 622, TCI 623 and TCI 624 can be represented as “00”, “01”, “10” and “11”, respectively. Only as an example, the TCI 621, TCI 622 and TCI 623 can be applied for the format 1_2. In this case, if the DCI field indicates “11”, it means that the DCI filed indicates one of: the latest or current applied TCI state(s), the latest or current indicated TCI state(s) in DCI format 1_1, or the TCI state(s) indicated in DCI format 1_1 in latest PDCCH before or earlier or no later than the PDCCH with DCI format 1_2. If the DCI filed indicates any one of “00”, “01” and “10”, the terminal device 110-1 may determine the TCI state(s) based on the DCI after the application timing.

In some embodiments, the size of TCI field in the different DCI formats (for example, DCI format 1_1 and DCI format 1_2) may be the same. In other words, the terminal device 110-1 does not expect different size of TCI field in different DCI formats. For example, if the terminal device 110-1 is configured with dynamic beam/TCI state(s) indication, the number of codepoints in the DCI field ‘Transmission Configuration Indication’ of DCI format 1_2 is expected to be configured as 8. For another example, if the terminal device 110-1 is configured with dynamic beam/TCI state(s) indication, the number of bits in the DCI field ‘Transmission Configuration Indication’ of DCI format 1_2 is expected to be configured as 3 bits.

In some embodiments, the terminal device 110-1 may receive an activation command, for example, via at least one of RRC, MAC CE or DCI. And the activation command is used to map a first number of TCI states or a first number of combinations of a group of TCI states to the codepoints of the DCI field ‘Transmission Configuration Indication’. For example, in one CC/BWP or in a set of CCs/BWPs. In some embodiments, the first number may be represented as N1, and N1 is positive integer. For example, 1<=N1<=64. For another example, 1<=N1<=8. In some embodiments, the group of TCI states may include G TCI state(s). G is positive integer. For example, 1<=G<=8. For another example, G may be 1 or 2. For another example, G may be at least one of {1, 2, 3, 4}. In some embodiments, the number of TCI states in the group may be different for different codepoints. In some embodiments, the number of codepoints may be Nc. Nc may be 2 or 4 or 8. For example, for DCI format 1_1, the number of codepoints may be 8. For another example, for DCI format 1_2, the number of codepoints may be 2 or 4 or 8, which is configured by the network device. For example, via RRC.

In some embodiments, the number of bits for the DCI field ‘Transmission Configuration Indication’ in DCI format 1_1 may be 3 bits. For example, when the higher layer parameter tci-PresentInDCI is enabled. In some embodiments, the number of bits for the DCI field ‘Transmission Configuration Indication’ in DCI format 1_2 may be configured as 1 or 2 or 3 bits. For example, when the higher layer parameter tci-PresentInDCI-1-2 is configured. For example, when the number of bits is 1, then the number of codepoints Nc is 2. For another example, when the number of bits is 2, then the number of codepoints Nc is 4. For another example, when the number of bits is 3, then the number of codepoints Nc is 8.

In some embodiments, the terminal device may be configured with Nc codepoints in the DCI field ‘Transmission Configuration Indication’ of DCI format 1_2. In some embodiments, the first (Nc-1) or the last (Nc-1) codepoints in DCI format 1_2 are applied to indicate the first (Nc-1) TCI states or the first (Nc-1) combinations of a group of TCI states from the N1 TCI states or the N1 combinations of a group of TCI states. In some embodiments, one of the Nc codepoints (for example, the first one or the last one) in DCI format 1_2 may be applied to indicate the TCI state(s) is not changed or updated. In some embodiments, one of the Nc codepoints (for example, the first one or the last one) in DCI format 1_2 may be applied to indicate the current or latest applied or current latest to be applied TCI state(s).

In some embodiments, the terminal device 110-1 does not expect to be configured with the value of Nc is smaller than the value of N1. In some embodiments, the terminal device 110-1 expects to be configured with the value of Nc no less than or larger than the value of N1. For example, Nc>=N1.

Alternatively, when the DCI field ‘TCI’ is absent in DCI format 1_2 or when the DCI field ‘TCI’ is present in DCI format 1_2 and when the number of codepoints S in the DCI field ‘TCI’ of DCI format 1_2 is 0 or 1, the terminal device 110-1 may assume that the TCI state or the QCL assumption for the PDSCH is identical to the TCI state or QCL assumption whichever is applied at the time (or in the slot/subslot) when PDSCH is scheduled within the active bandwidth part (BWP) of the serving cell.

In some embodiments, the terminal device 110-1 may be configured/indicated with a first TCI for reception of PDSCH and/or all or a subset of CORESETs. For example, the first TCI is applied at the time (or in the slot/subslot) for a first PDCCH reception. In some embodiments, the terminal device 110-1 may receive or detect a DCI in the first PDCCH with the first TCI. In some embodiments, the DCI may be a DCI format without the field of ‘Transmission Configuration Indication’. For example, the DCI may be DCI format 1_0. In some embodiments, the number of bits for the field of ‘Transmission Configuration Indication’ is 0 in the DCI. For example, the DCI may be DCI format 1_2. In some embodiments, the DCI may schedule a PDSCH. In some embodiments, the terminal device 110-1 may be configured/indicated with a second TCI for reception of PDSCH and/or all or a subset of CORESETs. For example, the second TCI is applied at the time (or in the slot/subslot) for the PDSCH reception. In some embodiments, the terminal device 110-1 may receive the PDSCH with the second TCI.

In some embodiments, the first TCI may be a first DL TCI state or a first DL TCI state in a first pair of DL/UL TCI states or a first joint DL/UL TCI state. In some embodiments, the second TCI may be a second DL TCI state or a second DL TCI state in a second pair of DL/UL TCI states or a second joint DL/UL TCI state. In some embodiments, the first TCI is different from the second TCI.

In some embodiments, the terminal device 110-1 may be configured/indicated with a third TCI for reception of PDSCH and/or all or a subset of CORESETs. For example, the third TCI is applied at the time (or in the slot/subslot) for a first PDCCH reception. In some embodiments, the terminal device 110-1 may receive or detect the first PDCCH with the third TCI. For example, the first PDCCH is in a first CORESET. In some embodiments, the terminal device 110-1 may be indicated with a first TCI in a first DCI received or detected in the first PDCCH. In some embodiments, the first DCI may schedule a PDSCH or may not schedule a PDSCH. In some embodiments, the terminal device 110-1 may report the decoding result or a first HARQ-ACK information for at least one of the first DCI or the first PDCCH or the PDSCH scheduled by the first DCI to the network device 120. For example, the decoding result or the first HARQ-ACK information may be transmitted/reported in a first PUCCH or in a first PUSCH. In some embodiments, the terminal device 110-1 may be configured/indicated with a fourth TCI for transmission of PUSCH and/or all or a subset of PUCCH. For example, the fourth TCI is applied at the time (or in the slot/subslot) for the first PUCCH or the first PUSCH transmission. For example, the terminal device 110-1 may transmit the first PUCCH or the first PUSCH with the fourth TCI.

In some embodiments, the first application timing for the first TCI may be the first one slot or the first one subslot after X ms or Y symbols from the last symbol of the first PUCCH or the first PUSCH. In some embodiments, the terminal device 110-1 may receive PDSCH and/or all or the subset of CORESETs with the first TCI from the first one slot or the first one subslot or after/from the first application timing. In some embodiments, the terminal device 110-1 may transmit PUSCH and/or all or the subset of PUCCH with the first TCI from the first one slot or the first one subslot or after/from the first application timing.

In some embodiments, the terminal device 110-1 may not expect to receive or detect a second PDCCH within a duration. And the DCI in the second PDCCH indicates a second TCI. For example, the second TCI is different from the first TCI. In some embodiments, the duration may be between the first or last symbol of the first PUCCH or the first PUSCH and the first application timing or the first symbol of the slot/subslot of the first application timing. In some embodiments, the duration may be between the first or last symbol of the first PDCCH and the first application timing or the first symbol of the slot/subslot of the first application timing. In some embodiments, the time and/or frequency resource for the second PUCCH or second PUSCH corresponding to the second PDCCH is different from the time and/or frequency resource for the first PUCCH or the first PUSCH. In some embodiments, the first or last symbol for the second PUCCH or second PUSCH corresponding to the second PDCCH is earlier or no later than the first or last symbol for the first PUCCH or the first PUSCH. For example, the DCI in the second PDCCH may not schedule a PDSCH.

In some embodiments, the first TCI may be a first DL TCI state or a first DL TCI state in a first pair of DL/UL TCI states, and the second TCI may be a second DL TCI state or a second DL TCI state in a second pair of DL/UL TCI states. In some embodiments, the first TCI may be a first UL TCI state or a first UL TCI state in a first pair of DL/UL TCI states, and the second TCI may be a second UL TCI state or a second UL TCI state in a second pair of DL/UL TCI states. In some embodiments, the first DL TCI state may be different from the second DL TCI state. In some embodiments, the first UL TCI state may be different from the second UL TCI state. In some embodiments, the first pair of DL/UL TCI states may be different from the second pair of DL/UL TCI states. In some embodiments, the first TCI may be a first joint DL/UL TCI state, and the second TCI may be a second joint DL/UL TCI state. In some embodiments, the first joint DL/UL TCI state may be different from the second joint DL/UL TCI state.

In other embodiments, for enhanced mobile broadband (cMBB) services and ultra-reliable low latency (URLLC) services, the TCI state can be indicated or applied dynamically. In some embodiments, the terminal device 110-1 may receive a third PDCCH on a first CORESET with the first TCI and a first PDSCH with the first TCI. In this case, the terminal device 110-1 may also transmit a first PUCCH with the first TCI to the network device 120 and transmit a first PUSCH with the first TCI to the network device 120. In addition, the terminal device 110-1 may receive a fourth PDCCH on a second CORESET with the second TCI and a second PDSCH with the second TCI. In this case, the terminal device 110-1 may also transmit a second PUCCH with the second TCI to the network device 120 and transmit a second PUSCH with the second TCI to the network device 120. For example, the corresponding CORESET for first PDCCH is configured for DCI format 1_1 and/or DCI format 1_0/0_1/0_0/0_2/2_0/2_1/2_2/2_3 (not for DCI format 1_2), and the corresponding CORESET for the second PDCCH is configured for DCI format 1_2 and/or DCI format 1_0/0_1/0_0/0_2/2_0/2_1/2_2/2_3 (not for DCI format 1_1). As another example, the latest applied TCI state(s) from DCI format 1_1 is applied for DCI format 1_0/0_1/0_0/0_2/2_0/2_1/2_2/2_3 and/or corresponding scheduling.

In some embodiments, if the reception of the first PDCCH and the reception of the second PDCCH are within a duration, the first TCI state and the second TCI state should be the same. In other words, the indicated TCI states within the duration are expected to be same. The duration can be any suitable length. For example, the duration may be one slot. Alternatively, for another example, the duration can be a subslot. As another example, the duration may be a span for PDCCH monitoring. For another example, the duration can also be a PDCCH monitoring occasion.

Alternatively, there may be a minimum duration between two different indicated TCI states. The minimum duration can be predefined or preconfigured. The minimum duration can be any suitable length. For example, the minimum duration can be a slot. In this case, if the first PDCCH and the second PDCCH are transmitted within one slot, the first TCI state indicated in the first PDCCH and the second TCI state indicated in the second PDCCH can be the same. If the duration between the transmission of the first PDCCH and the transmission of the second PDCCH are longer than one slot, the first TCI state indicated in the first PDCCH and the second TCI state indicated in the second PDCCH can be different.

In other embodiments, if the first PDCCH indicates the first TCI state, the second PDCCH will not indicate the second TCI state. In another saying, the terminal device 110-1 does not expect to be indicated with a second TCI state if there is a first TCI is to be applied. For example, the terminal device 110-1 doesn't expect to be indicated with a second TCI state in a second PDCCH within the duration between a first PDCCH with a first TCI state indication and the application timing for the first TCI state. In this example, the resource for the HARQ feedback corresponding the first PDCCH is different from (or later than) the resource for the HARQ feedback corresponding to the second PDCCH. The second TCI state can be different from the first TCI state. For example, the second PDCCH is without data assignment.

In some embodiments, for common TCI framework, TCI state for PDSCH scheduled by DCI 1_0 may be different from the scheduling PDCCH. If the PDSCH is scheduled by a DCI format not having the TCI field present, and the time offset between the reception of the DL DCI and the corresponding PDSCH of a serving cell is equal to or greater than a threshold timeDurationForQCL if applicable, the terminal device 110-1 may assume that the TCI state or the QCL assumption for the PDSCH is identical to the TCI state or QCL assumption whichever is applied at the time (or in the slot/subslot) when PDSCH is scheduled within the active BWP of the serving cell. The threshold timeDurationForQCL can be determined based on the reported UE capability [13, TS 38.306], for determining PDSCH antenna port quasi co-location.

Regarding application time of the beam indication, the first slot for applying the beam that is at least X ms or Y symbols after the last symbol of the acknowledgment of the joint or separate DL/UL beam indication. The value of X/Y can depend on a first time duration and a second time duration. The first time duration (which can be represented as Z) may be timeDurationForQCL or beamSwitchTiming, and the second time duration (which can be represented as W) may be between the last symbol of PDCCH for the beam indication and the last symbol of the acknowledgement of the beam indication. In this case, if Z is smaller than W, the value of X/Y can be 0. Alternatively, if Z is not smaller than W, the value of X/Y can be the difference between Z and W.

In some embodiments, there may be M TRPs serving the terminal device 110-1, where M is a positive integer. For example, 1≤M≤4. For another example, M=2. In some example embodiments, for each of the M TRPs, the terminal device 110-1 may be configured with at least one of the following: a control resource set (CORESET), a SRS resource set, a set of spatial relation information, a transmission configuration indicator (TCI) state, and a set of QCL parameters. That is, the terminal device 110-1 may be configured with M CORESETs, M SRS resource sets, M sets of spatial relation information, M TCI states and/or M sets of QCL parameters associated with M TRPs respectively. One of the M TRPs can be represented by a corresponding one of the M CORESETs, the M SRS resource sets, the M sets of spatial relation information, the M TCI states and/or the M sets of QCL parameters.

In some embodiments, the SRS resource sets are configured for codebook based uplink transmission. In some example embodiments, the SRS resource sets are configured for non-codebook based uplink transmission. In some embodiments, a first TRP may be associated with a first CORESET, a first SRS resource set, first spatial relation information, a first TCI state and/or a first set of QCL parameters, and a second TRP may be associated with a second CORESET, a second SRS resource set, second spatial relation information, a second TCI state and/or a second set of QCL parameters.

In some embodiments, the first TRP and the second TRP may correspond to different SRS resource sets. In the following text, the SRS resource set corresponding to the first TRP may be referred to as the first SRS resource set, while the SRS resource set corresponding to the second TRP may be referred to as the second SRS resource set.

In some embodiments, the DCI for scheduling the PUSCH of the terminal device 110-1 may comprise a plurality of SRS resource indicator (SRI) fields corresponding to the plurality of SRS resource sets. In some embodiments, the DCI may comprise two SRI fields. In the following text, the SRI field corresponding to the first SRS resource set may be referred to as the first SRI field, while the SRI field corresponding to the second SRS resource set may be referred to as the second SRI field.

In some embodiments, codebook based PUSCH transmission and/or non-codebook based PUSCH transmission are supported. For single DCI based multi-TRP PUSCH repetition scheme, non-codebook based PUSCH transmissions can be scheduled by DCI format 0_0, DCI format 0_1, DCI format 0_2 or semi-statically configured parameters, where the DCI or the parameters may comprise the first and second SRI fields corresponding to first and second SRS resource sets, respectively. Additionally, for non-codebook based PUSCH transmissions, the first SRI field may be based on the legacy structure (such as, the structure as specified in Release 15/16 of 3rd Generation Partnership Project (3GPP)), and may be used to indicate the number of SRS resources, the number of transmission layers (also referred to as “transmission rank”), and the likes. The second SRI field may only indicate the number of SRS resources, the number of transmission layers is assumed to be the same that of the first SRI field.

Additionally, for non-codebook based multi-TRP PUSCH transmissions, the first SRI field is used to determine the entry of the second SRI field which only contains the SRI(s) combinations corresponding to the indicated rank (i.e, number of layers) of the first SRI field. The number of bits, N₂, for the second SRI field is determined by the maximum number of codepoint(s) per rank among all ranks associated with the first SRI field. For each rank x, the first Kx codepoint(s) are mapped to Kx SRIs of rank x associated with the first SRI field, the remaining (2^{N}^{₂}-Kx) codepoint(s) are reserved. For example, N₂ may be 1 or 0, when there is one SRS resource in a SRS resource set for non-codebook based transmission. For example, the SRS resource set may be the second SRS resource set.

In some example embodiments, the terminal device 110-1 may determine its PUSCH precoder and transmission rank based on the SRI when multiple SRS resources are configured, where the SRI is given by the SRS resource indicator in DCI format 0_1 and DCI format 0_2, or the SRI is given by a higher layer parameter, for example srs-ResourceIndicator. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The terminal device 110-1 may use one or more SRS resources for SRS transmission, where the maximum number of SRS resources in a SRS resource set and the maximum number of SRS resources that can be configured to the terminal device 110-1 for simultaneous transmission in a same symbol depend on capabilities of terminal device 110-1. The SRS resources transmitted simultaneously occupy the same resource blocks (RBs). For each SRS resource, only one SRS port may be configured. One or two SRS resource sets can be configured with the higher layer parameter usage in SRS-ResourceSet set to ‘nonCodebook’. The maximum number of SRS resources in a SRS resource set that can be configured for non-codebook based uplink transmission may be 4. The indicated SRI in slot n may be associated with the most recent transmission of SRS resource(s) identified by the SRI, where the SRS transmission is prior to the PDCCH carrying the SRI.

As for single DCI based M-TRP PUSCH repetition schemes, codebook based PUSCH transmissions can be scheduled by DCI format 0_0, DCI format 0_1, DCI format 0_2 or semi-statically configured parameters. The DCI or the parameters may comprise the first and second SRI fields corresponding to first and second SRS resource sets, respectively. Additionally, the DCI may comprise two TPMI fields corresponding to the first and second TRP, respectively. The TPMI is used to indicate the precoder to be applied over the layers {0 . . . v-1} and that corresponds to the SRS resource selected by the SRI when multiple SRS resources are configured. Alternatively, if a single SRS resource in one SRS resource set is configured, TPMI is used to indicate the precoder to be applied over the layers {0 . . . v-1} and that corresponds to the SRS resource. In some example embodiments, the first TPMI field may include TPMI index and the number of layers, while the second TPMI field only includes the second TPMI index. The same number of layers as indicated in the first TPMI field is applied to the second TPMI field.

Further, for codebook based (CB) multi-TRP PUSCH transmission, the first TPMI field is used to determine the entry of the second TPMI field, while the second TPMI field only contains TPMIs corresponding to the indicated rank (number of layers) of the first TPMI field. The bit width of the second TPMI field, M₂, is determined by the maximum number of TPMIs per rank among all ranks associated with the first TPMI field. For each rank y, the first K_{y} codepoint(s) of the second TPMI field are mapped to K_{y} TPMI(s) of rank y associated with the first TPMI field in increasing order codepoint index, the remaining (2^{M}^{₂}-Ky) codepoint(s) are reserved. For example, M₂ may be 1 or 0, when the number of ports is 1 for the SRS resource(s) in a SRS resource set for codebook based transmission. For example, the SRS resource set may be the second SRS resource set.

In some embodiments, the terminal device 110-1 may determine its PUSCH transmission precoder based on the SRI, the TPMI and the transmission rank, where the SRI, the TPMI and the transmission rank are given by DCI fields of SRS resource indicator, precoding information and the number of layers in DCI format 0_1 and 0_2, or given by higher layer parameters, for example, srs-ResourceIndicator and precodingAndNumberOfLayers. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The TPMI is used to indicate the precoder to be applied over the layers {0 . . . v-1} and that corresponds to the SRS resource selected by the SRI when multiple SRS resources are configured. Alternatively, if a single SRS resource is configured, TPMI is used to indicate the precoder to be applied over the layers {0 . . . v-1} and that corresponds to the SRS resource. The transmission precoder is selected from the uplink codebook that has a number of antenna ports equal to the higher layer parameter nrofSRS-Ports in SRS-config. When the terminal device 110-1 is configured with the higher layer parameter txConfig set to ‘codebook’, the terminal device 110-1 may be configured with at least one SRS resource. The indicated SRI in slot n may be associated with the most recent transmission of SRS resource identified by the SRI, where the SRS resource is prior to the PDCCH carrying the SRI.

Additionally, in some example embodiments, the DCI may comprise a plurality of transmission power control (TPC) field.

In some embodiments, the network device 110 may configure a plurality of SRS resource sets (for example, the plurality of SRS resource sets may be 1 or 2 for codebook based uplink/PUSCH transmission. For another example, the plurality of SRS resource sets may be 1 or 2 for non-codebook based uplink/PUSCH transmission) to the terminal device 110-1 (for example, a first SRS resource set to be applied for PUSCH transmissions via the first TRP and a second SRS resource set to be applied for PUSCH transmissions via the second TRP). In some example embodiments, the network device 110 may configure codebook based uplink/PUSCH transmission to the terminal device 110-1, and the network device 110 may configure one or two SRS resource sets to the terminal device 110-1. For example, the one or two SRS resource sets are applied for codebook based uplink/PUSCH transmission. In some example embodiments, the network device 110 may configure non-codebook based uplink/PUSCH transmission to the terminal device 110-1, and the network device 110 may configure one or two SRS resource sets to the terminal device 110-1. For example, the one or two SRS resource sets are applied for non-codebook based uplink/PUSCH transmission. In some example embodiments, the network device 110 may transmit DCI to the terminal device 110-1 for scheduling at least one PUSCH transmission. In some example embodiments, the DCI may comprise a plurality of SRI fields corresponding to the plurality of SRS resources sets. For example, the plurality of SRI fields may comprise a first SRI field and a second SRI field. Additionally, or in addition, the DCI may comprise a plurality of TPMI fields for codebook uplink/PUSCH transmission (for example, the first TPMI field and second TPMI field). Additionally, or in addition, the DCI may comprise a plurality of TPC fields (for example, a first TPC field and a second TPC field).

In addition, a dynamic switching between multi-TRP and/or multi-panel and single-TRP may be supported. More specifically, if single-TRP transmission with the first TRP is dynamically indicated by DCI, the first SRS resource set is to be applied for PUSCH transmissions. If single-TRP transmission with the second TRP is to be dynamically indicated by DCI, the second SRS resource set may be applied for PUSCH transmissions. Alternatively, if multi-TRP transmission is dynamically indicated, the first and second SRS resource sets may be applied for PUSCH transmissions.

Additionally, the multi-TRP transmission may be associated with an order of the TRPs (i.e., an order of multiple SRS resource sets to be applied for PUSCH transmission). One example of the order is that the terminal device 110-1 applies the first SRS resource set for the first PUSCH transmission/repetition of the at least one PUSCH transmission. Another example of the order is that the terminal device 110-1 applies the second SRS resource set for the first PUSCH transmission/repetition of the at least one PUSCH transmission.

In some example embodiments, the terminal device 110-1 may be configured/indicated/scheduled with a set of PUSCH transmissions. The set of PUSCH transmissions may comprise a first subset of PUSCH transmissions and a second subset of PUSCH transmissions. In some example embodiments, the precoder for the first subset of PUSCH transmissions/repetitions may be determined based on at least one of the first SRI indicated by the first SRI field, the first TPMI/PMI field and the transmission rank. The precoder for the second subset of PUSCH transmissions/repetitions may be determined based on at least one of the second SRI indicated by the second SRI field, the second TPMI/PMI field and the transmission rank.

In some example embodiments, at least one SRS resource in the first SRS resource set may be applied for or associated with the first subset of PUSCH transmissions and at least one SRS resource in the second SRS resource set may be applied for or associated with the second subset of PUSCH transmissions. In some example embodiments, the first subset of PUSCH transmissions or the precoder for the first subset of PUSCH transmissions may be based on or correspond to at least one SRS resource in the first SRS resource set and the second subset of PUSCH transmissions or the precoder for the second subset of PUSCH transmissions may be based on or correspond to at least one SRS resource in the second SRS resource set.

In some embodiments, if there are X SRS resources in the first resource set, and Y SRS resources in the second resource set, X and Y are positive integer. For example, 1<=X<=4. For another example, 1<=Y<=4. In some embodiments, X is smaller than Y. In some embodiments, the size of the first SRI field is determined based on the value of X. For example, the number of bits for the first SRI field may be ceil(log 2(X)). In some embodiments, the terminal device 110-1 may be configured or indicated that the first SRI field is associated with the second SRS resource set, and if X<Y, the first 2^{ceil(log 2(X))} SRS resources in the second SRS resource sets are indicated by the first SRI field.

In some embodiments, the terminal device 110-1 may be configured with codebook based uplink transmission. And the terminal device 110-1 may be configured with two SRS resource sets. In some embodiments, the first SRS resource set includes 1 SRS resource. And the second SRS resource set includes 2 or 3 or 4 SRS resources. In some embodiments, when the terminal device 110-1 is indicated to associate the first SRI field with the second SRS resource set, the first SRS resource in the second SRS resource set is assumed or applied. For example, the SRS resource with lower value of identity (ID). In some embodiments, the first SRS resource set includes 2 SRS resources. And the second SRS resource set includes 3 or 4 SRS resources. In some embodiments, when the terminal device 110-1 is indicated to associate the first SRI field with the second SRS resource set, the first two SRS resources in the second SRS resource set is assumed or applied. For example, the two SRS resources with lower IDs. For example, the number of bits for the first SRI field is 1. For example, when the value of the first SRI field is indicated as 0, the first SRS resource in the second SRS resource is assumed or applied. For another example, when the value of the first SRI field is indicated as 1, the second SRS resource in the second SRS resource is assumed or applied. In some embodiments, the first SRS resource set includes 3 SRS resources. And the second SRS resource set includes 4 SRS resources. In some embodiments, when the terminal device 110-1 is indicated to associate the first SRI field with the second SRS resource set, the four SRS resources in the second SRS resource set is assumed or applied. For example, the number of bits for the first SRI field is 2. For example, when the value of the first SRI field is indicated as 00, the first SRS resource in the second SRS resource is assumed or applied. For another example, when the value of the first SRI field is indicated as 01, the second SRS resource in the second SRS resource is assumed or applied. For another example, when the value of the first SRI field is indicated as 10, the third SRS resource in the second SRS resource is assumed or applied. For another example, when the value of the first SRI field is indicated as 11, the fourth SRS resource in the second SRS resource is assumed or applied. For another example, when the terminal device 110-1 is indicated to associate the first SRI field with the first SRS resource set, the value of the first SRI field with 11 is reserved.

In some embodiments, the terminal device 110-1 may be configured with non-codebook based uplink transmission. And the terminal device 110-1 may be configured with two SRS resource sets. In some embodiments, the first SRS resource set includes 1 SRS resource. And the second SRS resource set includes 2 or 3 or 4 SRS resources. In some embodiments, when the terminal device 110-1 is indicated to associate the first SRI field with the second SRS resource set, the first SRS resource in the second SRS resource set is assumed or applied. For example, the SRS resource with lower value of identity (ID). In some embodiments, the first SRS resource set includes 2 SRS resources. And the second SRS resource set includes 3 or 4 SRS resources. In some embodiments, when the terminal device 110-1 is indicated to associate the first SRI field with the second SRS resource set, the first two SRS resources in the second SRS resource set is assumed or applied. For example, the two SRS resources with lower IDs. For example, the bit field in the first SRI field indicates one or two SRS resources of the first two SRS resources in the second SRS resource set. In some embodiments, the first SRS resource set includes 3 SRS resources. And the second SRS resource set includes 4 SRS resources. In some embodiments, when the terminal device 110-1 is indicated to associate the first SRI field with the second SRS resource set, the first three SRS resources in the second SRS resource set is assumed or applied. For example, the two SRS resources with lower IDs. For example, the bit field in the first SRI field indicates one or two or three SRS resources of the first three SRS resources in the second SRS resource set.

For example, the first SRI field cannot indicate all available candidates for the second SRS resource set. For example, for codepoint 01, the second SRS resource set is applied, and the first SRI field is applied. But there may be some SRS resource(s) cannot be indicated by the first SRI field. For example, for codebook (CB), if X is 1 and Y is 2, the first SRI field is 0 bit. And for codepoint 01, the first SRI field is applied for the second SRS resource set. In this case, it is not clear which one of the two SRS resources in the second resource set is applied. Therefore, according to some embodiments of the present disclosure, if the number of SRS resources in the first SRS resource set is X and the number of SRS resource set in the second SRS resource set is Y and X is smaller than Y, the first SRI field can be associated with the second SRS resource set. For example, the first 2\hat{ }X SRS resources from the Y SRS resources can be indicated by the first SRI field. Table 1 below shows an example of CB first SRI field where X is 2 and Y is 4.

TABLE 1

| Bit field mapped to index | SRI (s) |
|---|---|
| 0 | 0 |
| 1 | 1 |

According to Table 1, the SRI “0” can indicate the first SRS resource and the SRI “1” can indicate the second SRS resource. Table 2 below shows an example of NCB first SRI field where X is 2 and Y is 4.

TABLE 2

| Bit field mapped to index | SRI (s) |
|---|---|
| 0 | 0 |
| 1 | 1 |
| 2 | 0, 1 |
| 3 | Reserved |

According to Table 2, the index “0” and “2” can indicate the first SRS resource and the index “1” and “2” can indicate the second SRS resource.

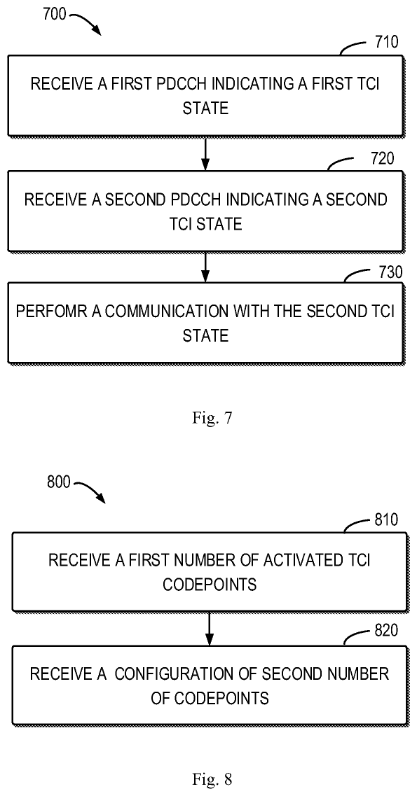

FIG. 7 shows a flowchart of an example method 700 in accordance with an embodiment of the present disclosure. Only for the purpose of illustrations, the method 700 can be implemented at a terminal device 110-1 as shown in FIG. 1.

At block 710, the terminal device 110-1 receives a first PDCCH from the network device 120. The first PDCCH indicates a first TCI state.

At block 720, the terminal device 110-1 receives a second PDCCH from the network device 120. The second PDCCH indicates second first TCI state.

At block 730, if the reception of the second PDCCH is later than the reception of the first PDCCH, the terminal device 110-1 performs a communication with the network device 120 with the second TCI state after a period of time.

In some embodiments, the terminal device 110-1 may transmit, to the network device 120, a second HARQ feedback which corresponds to a second scheduling based on the second PDCCH. The terminal device 110-1 may also transmit, to the network device 120, a first HARQ feedback which corresponds to a first scheduling based on the first PDCCH. If the transmission of the first HARQ feedback is later than the transmission of the second HARQ feedback, the terminal device 110-1 may perform the communication with the network device with the second TCI after the period of time. In this situation, the first scheduling can be a PDSCH scheduling based on the first PDCCH. The second scheduling can be a TCI state indication without PDSCH scheduling based on the second PDCCH or a PDSCH scheduling based on the second PDCCH. In an example embodiment, if the first TCI is applicable and the second TCI state is inapplicable, the terminal device 110-1 may perform the communication with the network device with the first TCI after the period of time.

If a first field of the first TCI state in the first PDCCH comprises a first number of bits and a second field of the second TCI state in the second PDCCH comprises a second number of bits and the second number is smaller than the first number, predetermined values of bits in the second field are to indicate the first TCI state.

Alternatively or in addition, the terminal device 110-1 may perform the communication with the network device with the first TCI. For example, the terminal device 110-1 may receive, from the network device 120, a third PDCCH on a first control resource set (CORESET) with the first TCI. In addition, the terminal device 110-1 may receive, from the network device 120, a first physical downlink shared channel (PDSCH) with the first TCI. Additionally or alternatively, the terminal device 110-1 may transmit, to the network device 120, a first physical uplink control channel (PUCCH) with the first TCI. The terminal device 110-1 may also transmit, to the network device 120, a first physical uplink shared channel (PUSCH) with the first TCI.

In other embodiments, the terminal device 110-1 may receive, from the network device 120, a fourth PDCCH on a second control resource set (CORESET) with the second TCI. Alternatively, the terminal device 110-1 may receive, from the network device 120, a second physical downlink shared channel (PDSCH) with the second TCI. Additionally, the terminal device 110-1 may transmit, to the network device 120, a second physical uplink control channel (PUCCH) with the first TCI. Alternatively or in addition, the terminal device 110-1 may transmit, to the network device 120, a second physical uplink shared channel (PUSCH) with the second TCI.

In some embodiments, if the reception of the first PDCCH and the reception of the second PDCCH are within a duration, the first TCI state is the same as the second TCI state.

FIG. 8 shows a flowchart of an example method 800 in accordance with an embodiment of the present disclosure. Only for the purpose of illustrations, the method 800 can be implemented at a terminal device 110-1 as shown in FIG. 1.

At block 810, the terminal device 110-1 receives, from a network device 120, a first number of activated transmission configuration indicator (TCI) codepoints.

At block 820, the terminal device 110-1 receives, from a network device 120, a configuration of a second number of codepoints in a downlink control information (DCI) field. The second number is smaller than the first number; and one predetermined value of the DCI field is to indicate a same TCI state which has been applied for a communication with the network device.

Alternatively or in addition, the terminal device 110-1 may perform the communication with the network device with the first TCI. For example, the terminal device 110-1 may receive, from the network device 120, a third PDCCH on a first control resource set (CORESET) with the first TCI. In addition, the terminal device 110-1 may receive, from the network device 120, a first physical downlink shared channel (PDSCH) with the first TCI. Additionally or alternatively, the terminal device 110-1 may transmit, to the network device 120, a first physical uplink control channel (PUCCH) with the first TCI. The terminal device 110-1 may also transmit, to the network device 120, a first physical uplink shared channel (PUSCH) with the first TCI.

In other embodiments, the terminal device 110-1 may receive, from the network device 120, a fourth PDCCH on a second control resource set (CORESET) with the second TCI. Alternatively, the terminal device 110-1 may receive, from the network device 120, a second physical downlink shared channel (PDSCH) with the second TCI. Additionally, the terminal device 110-1 may transmit, to the network device 120, a second physical uplink control channel (PUCCH) with the first TCI. Alternatively or in addition, the terminal device 110-1 may transmit, to the network device 120, a second physical uplink shared channel (PUSCH) with the second TCI.

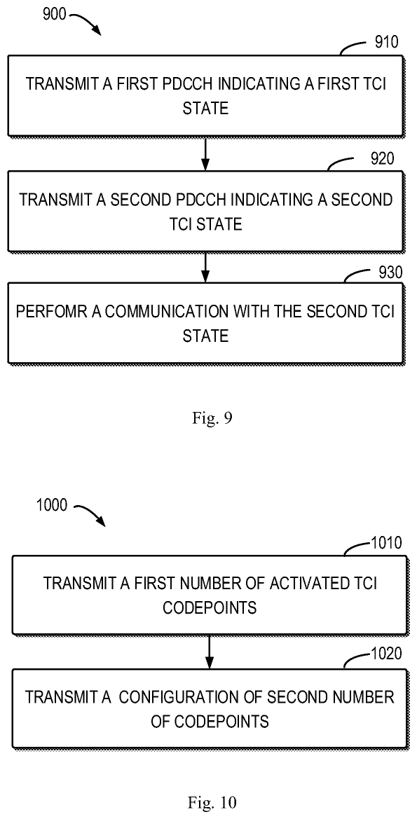

FIG. 9 shows a flowchart of an example method 900 in accordance with an embodiment of the present disclosure. Only for the purpose of illustrations, the method 900 can be implemented at a network device 120 as shown in FIG. 1.

At block 910, the network device 120 transmits, to the terminal device 110-1, a first PDCCH. The first PDCCH indicates a first TCI state.

At block 920, the network device 120 transmits, to the terminal device 110-1, a second PDCCH. The second PDCCH indicates a second TCI state.

At block 930, if the reception of the second PDCCH is later than the reception of the first PDCCH, the network device 120 performs a communication with the terminal device 110-1 with the second TCI state after a period of time.

In some embodiments, the network device 120 may receive, from the terminal device 110-1, a second HARQ feedback corresponding to a second scheduling based on the second PDCCH. The network device 120 may receive, from the terminal device 110-1, a first HARQ feedback corresponding to a first scheduling based on. Additionally, if the reception of the first HARQ feedback is later than the reception of the second HARQ feedback, the network device 120 may perform the communication with the terminal device 110-1 with the second TCI after the period of time. In this situation, the first scheduling is a PDSCH scheduling based on the first PDCCH and the second scheduling is a TCI state indication without PDSCH scheduling based on the second PDCCH or a PDSCH scheduling based on the second PDCCH.

Alternatively, if the first TCI is applicable and the second TCI state is inapplicable, the network device 120 may perform the communication with the terminal device with the first TCI after the period of time.

In some embodiments, if a first field of the first TCI state in the first PDCCH comprises a first number of bits and a second field of the second TCI state in the second PDCCH comprises a second number of bits and the second number is smaller than the first number, predetermined values of bits in the second field are to indicate the first TCI state.

Alternatively or in addition, the network device 120 can perform the communication with the terminal device with the first TCI. For example, the network device 120 can transmit, to the terminal device 110-1, a third PDCCH on a first control resource set (CORESET) with the first TCI. The network device 120 can also transmit, to the terminal device 110-1, a first physical downlink shared channel (PDSCH) with the first TCI. Alternatively or in addition, the network device 120 may receive, from the terminal device 110-1, a first physical uplink control channel (PUCCH) with the first TCI. Additionally, the network device 120 may receive, from the terminal device 110-1, a first physical uplink shared channel (PUSCH) with the first TCI.

In other embodiments, the network device 120 may perform the communication with the terminal device with the second TCI comprises at least one of: transmitting, to the terminal device, a fourth PDCCH on a second control resource set (CORESET) with the second TCI; transmitting, to the terminal device, a second physical downlink shared channel (PDSCH) with the second TCI; receiving, from the terminal device, a second physical uplink control channel (PUCCH) with the first TCI; or receiving, from the terminal device, a second physical uplink shared channel (PUSCH) with the second TCI.

In some embodiments, if the reception of the first PDCCH and the reception of the second PDCCH are within a duration, the first TCI state is the same as the second TCI state.

FIG. 10 shows a flowchart of an example method 1000 in accordance with an embodiment of the present disclosure. Only for the purpose of illustrations, the method 1000 can be implemented at a network device 120 as shown in FIG. 1.

At block 1010, the network device 120 transmits, to a terminal device 110-1, a first number of activated transmission configuration indicator (TCI) codepoints.

At block 1020, the network device 120 transmits, to a terminal device 110-1, a configuration of a second number of codepoints in a downlink control information (DCI) field. The second number is smaller than the first number; and one predetermined value of the DCI field is to indicate a same TCI state which has been applied for a communication with the network device.

Alternatively or in addition, the network device 120 may perform the communication with the terminal device 110-1 with the first TCI. For example, the network device 120 may transmit, to the terminal device 110-1, a third PDCCH on a first control resource set (CORESET) with the first TCI. In addition, the network device 120 may transmit, to the terminal device 110-1, a first physical downlink shared channel (PDSCH) with the first TCI. Additionally or alternatively, the network device 120 may receive, from the terminal device 110-1, a first physical uplink control channel (PUCCH) with the first TCI. The network device 120 may receive, from the terminal device 110-1, a first physical uplink shared channel (PUSCH) with the first TCI.

Alternatively or in addition, the network device 120 may perform the communication with the terminal device 110-1 with the second TCI. For example, the network device 120 may transmit, to the terminal device 110-1, a fourth PDCCH on a second control resource set (CORESET) with the first TCI. In addition, the network device 120 may transmit, to the terminal device 110-1, a second physical downlink shared channel (PDSCH) with the second TCI. Additionally or alternatively, the network device 120 may receive, from the terminal device 110-1, a second physical uplink control channel (PUCCH) with the second TCI. The network device 120 may receive, from the terminal device 110-1, a second physical uplink shared channel (PUSCH) with the second TCI.

In some embodiments, the terminal device comprises circuitry configured to receive, from a network device, a first physical downlink control channel (PDCCH) indicating a first transmission configuration indicator (TCI) state; receive, from the network device, a second PDCCH indicating a second TCI state; and in accordance with a determination that the reception of the second PDCCH is later than the reception of the first PDCCH, perform a communication with the network device with the second TCI state after a period of time.

In some embodiments, the terminal device comprises circuitry further configured to transmit, to the network device, a second hybrid automatic repeat request (HARQ)feedback corresponding to a second scheduling based on the second PDCCH; transmit, to the network device, a first HARQ feedback corresponding to a first scheduling based on the first PDCCH. The terminal device comprises circuitry configured to perform the communication with the network device with the second TCI state by: in accordance with the determination that the transmission of the first HARQ feedback is later than the transmission of the second HARQ feedback, performing the communication with the network device with the second TCI after the period of time.

In some embodiments, the first scheduling is a PDSCH scheduling based on the first PDCCH; the second scheduling is a TCI state indication without PDSCH scheduling based on the second PDCCH or a PDSCH scheduling based on the second PDCCH.

In some embodiments, the terminal device comprises circuitry further configured to in accordance with a determination that the first TCI is applicable and the second TCI state is inapplicable, perform the communication with the network device with the first TCI after the period of time.

In some embodiments, if a first field of the first TCI state in the first PDCCH comprises a first number of bits and a second field of the second TCI state in the second PDCCH comprises a second number of bits and the second number is smaller than the first number, predetermined values of bits in the second field are to indicate the first TCI state.

In some embodiments, the terminal device comprises circuitry further configured to perform the communication with the network device with the first TCI. In some embodiments, the terminal device comprises circuitry further configured to perform the communication with the network device with the first TCI by at least one of: receiving, from the network device, a third PDCCH on a first control resource set (CORESET) with the first TCI; receiving, from the network device, a first physical downlink shared channel (PDSCH) with the first TCI; transmitting, to the network device, a first physical uplink control channel (PUCCH) with the first TCI; or transmitting, to the network device, a first physical uplink shared channel (PUSCH) with the first TCI.

In some embodiments, the terminal device comprises circuitry further configured to perform the communication with the network device with the second TCI by at least one of: receiving, from the network device, a fourth PDCCH on a second control resource set (CORESET) with the second TCI; receiving, from the network device, a second physical downlink shared channel (PDSCH) with the second TCI; transmitting, to the network device, a second physical uplink control channel (PUCCH) with the first TCI; or transmitting, to the network device, a second physical uplink shared channel (PUSCH) with the second TCI.

In some embodiments, if the reception of the first PDCCH and the reception of the second PDCCH are within a duration, the first TCI state is the same as the second TCI state.

In some embodiments, a terminal device comprises circuitry configured to receive, to a network device, a first number of activated transmission configuration indicator (TCI)codepoints; and receive, from the network device, a configuration of a second number of codepoints in a downlink control information (DCI) field, wherein the second number is smaller than the first number; and one predetermined value of the DCI field is to indicate a same TCI state which has been applied for a communication with the network device.

In some embodiments, the terminal device comprises circuitry further configured to perform the communication with the network device with the TCI state. In some embodiments, the terminal device comprises circuitry further configured to perform the communication with the network device with the TCI state by at least one of: receiving, from the network device, a PDCCH on a control resource set (CORESET) with the TCI state; receiving, from the network device, a physical downlink shared channel (PDSCH) with the TCI state; transmitting, to the network device, a physical uplink control channel (PUCCH) with the TCI state; or transmitting, to the network device, a physical uplink shared channel (PUSCH) with the TCI state.

In some embodiments, a network device comprises circuitry configured to transmit, to a terminal device, a first physical downlink control channel (PDCCH) indicating a first transmission configuration indicator (TCI) state; transmit, to the terminal device, a second PDCCH indicating a second TCI state; and in accordance with a determination that the reception of the second PDCCH is later than the reception of the first PDCCH, perform a communication with the terminal device with the second TCI state after a period of time.

In some embodiments, the network device comprises circuitry configured to receive, from the terminal device, a second hybrid automatic repeat request (HARQ) feedback corresponding to a second scheduling based on the second PDCCH; receive, from the terminal device, a first HARQ feedback corresponding to a first scheduling based on. In some embodiments, the network device comprises circuitry configured to perform the communication with the terminal device with the second TCI state by: in accordance with the determination that the reception of the first HARQ feedback is later than the reception of the second HARQ feedback, performing the communication with the terminal device with the second TCI after the period of time.

In some embodiments, the first scheduling is a PDSCH scheduling based on the first PDCCH; the second scheduling is a TCI state indication without PDSCH scheduling based on the second PDCCH or a PDSCH scheduling based on the second PDCCH.

In some embodiments, the network device comprises circuitry configured to in accordance with a determination that the first TCI is applicable and the second TCI state is inapplicable, perform the communication with the terminal device with the first TCI after the period of time.

In some embodiments, if a first field of the first TCI state in the first PDCCH comprises a first number of bits and a second field of the second TCI state in the second PDCCH comprises a second number of bits and the second number is smaller than the first number, predetermined values of bits in the second field are to indicate the first TCI state.

In some embodiments, the network device comprises circuitry configured to perform the communication with the terminal device with the first TCI. In some embodiments, the network device comprises circuitry configured to perform the communication with the terminal device with the first TCI by at least one of: transmitting, to the terminal device, a third PDCCH on a first control resource set (CORESET) with the first TCI; transmitting, to the terminal device, a first physical downlink shared channel (PDSCH) with the first TCI; receiving, from the terminal device, a first physical uplink control channel (PUCCH) with the first TCI; or receiving, from the terminal device, a first physical uplink shared channel (PUSCH) with the first TCI.

In some embodiments, the network device comprises circuitry configured to perform the communication with the terminal device with the second TCI by at least one of: transmitting, to the terminal device, a fourth PDCCH on a second control resource set (CORESET) with the second TCI; transmitting, to the terminal device, a second physical downlink shared channel (PDSCH) with the second TCI; receiving, from the terminal device, a second physical uplink control channel (PUCCH) with the first TCI; or receiving, from the terminal device, a second physical uplink shared channel (PUSCH) with the second TCI.

In some embodiments, if the reception of the first PDCCH and the reception of the second PDCCH are within a duration, the first TCI state is the same as the second TCI state.

In some embodiments, the network device comprises circuitry configured to transmit, to a terminal device, a first number of activated transmission configuration indicator (TCI) codepoints; and transmit, to the terminal device, a configuration of a second number of codepoints in a downlink control information (DCI) field, wherein the second number is smaller than the first number; and one predetermined value of the DCI field is to indicate a same TCI state which has been applied for a communication with the network device.

In some embodiments, the network device comprises circuitry configured to perform the communication with the terminal device with the TCI state. In some embodiments, the network device comprises circuitry configured to perform the communication with the terminal device with the TCI state by at least one of: transmitting, to the terminal device, a PDCCH on a control resource set (CORESET) with the TCI state; transmitting, to the terminal device, a physical downlink shared channel (PDSCH) with the TCI state; receiving, from the terminal device, a physical uplink control channel (PUCCH) with the TCI state; or receiving, from the terminal device, a physical uplink shared channel (PUSCH) with the TCI state.

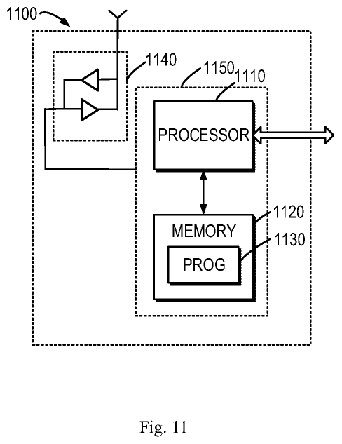

FIG. 11 is a simplified block diagram of a device 1100 that is suitable for implementing embodiments of the present disclosure. The device 1100 can be considered as a further example implementation of the network device 120, or the terminal device as shown in FIG. 1. Accordingly, the device 1100 can be implemented at or as at least a part of the terminal device 110, or the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones.

The communication interface may represent any interface that is necessary for communication with other network elements, such as X2 interface for bidirectional communications between eNBs, SI interface for communication between a Mobility Management Entity (MME)/Serving Gateway (S-GW) and the CNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1020 may form processing means adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1000, there may be several physically distinct memory modules in the device 1000. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-23. (canceled)

24. A method, performed by a terminal device, the method comprising:
receiving a downlink control information (DCI) format without downlink (DL) assignment, the DCI indicating a transmission configuration indicator (TCI) state; and
transmitting a physical uplink control channel (PUCCH) with a positive hybrid automatic repeat request-acknowledgement (HARQ-ACK) or a physical uplink shared channel (PUSCH) with a positive HARQ-ACK corresponding to the DCI,
wherein:
the TCI state is different from a previously indicated TCI state, and
the TCI state is applied from a first slot that is at least a time duration of one or more symbols after a last symbol of the PUCCH or the PUSCH.

25. The method of claim 24, wherein
the TCI state is one of a downlink (DL) TCI state, an uplink (UL) TCI state, or a joint DL/UL TCI state.

26. The method of claim 24, wherein
the DCI format is DCI format 1_1 or DCI format 1_2.

27. The method of claim 24, wherein
the time duration is configured via radio resource control (RRC) signaling.

28. The method of claim 24, wherein
a number of the one or more symbols in the time duration is equal to or larger than 1 and equal to or smaller than 336.

29. A method, performed by a terminal device, the method comprising:
receiving a downlink control information (DCI) format with downlink (DL) assignment, the DCI indicating a transmission configuration indicator (TCI) state; and
transmitting a physical uplink control channel (PUCCH) with a positive hybrid automatic repeat request-acknowledgement (HARQ-ACK) or a physical uplink shared channel (PUSCH) with a positive HARQ-ACK corresponding to a physical downlink shared channel (PDSCH) scheduled by the DCI,
wherein:
the TCI state is different from a previously indicated TCI state, and
the TCI state is applied from a first slot that is at least a time duration of one or more symbols after a last symbol of the PUCCH or the PUSCH.

30. A method, performed by a network device, the method comprising:
transmitting a downlink control information (DCI) format without downlink (DL) assignment, the DCI indicating a transmission configuration indicator (TCI) state; and
receiving a physical uplink control channel (PUCCH) with a positive hybrid automatic repeat request-acknowledgement (HARQ-ACK) or a physical uplink shared channel (PUSCH) with a positive HARQ-ACK corresponding to the DCI,
wherein:
the TCI state is different from a previously indicated TCI state, and
the TCI state is applied from a first slot that is at least a time duration of one or more symbols after a last symbol of the PUCCH or the PUSCH.

31. The method of claim 30, wherein
the TCI state is one of a downlink (DL) TCI state, an uplink (UL) TCI state, or a joint DL/UL TCI state.

32. The method of claim 30, wherein
the DCI format is DCI format 1_1 or DCI format 1_2.

33. The method of claim 30, wherein
the time duration is configured via radio resource control (RRC) signaling.

34. The method of claim 30, wherein
a number of the one or more symbols in the time duration is equal to or larger than 1 and equal to or smaller than 336.

35. A method, performed by a network device, the method comprising:
transmitting a downlink control information (DCI) format with downlink (DL) assignment, the DCI indicating a transmission configuration indicator (TCI) state; and
receiving a physical uplink control channel (PUCCH) with a positive hybrid automatic repeat request-acknowledgement (HARQ-ACK) or a physical uplink shared channel (PUSCH) with a positive HARQ-ACK corresponding to a physical downlink shared channel (PDSCH) scheduled by the DCI,
wherein:
the TCI state is different from a previously indicated TCI state, and
the TCI state is applied from a first slot that is at least a time duration of one or more symbols after a last symbol of the PUCCH or the PUSCH.
